(19) United States
(12) Patent Application Publication
(10) Pub. No.: US 2020/0261869 A1
(43) Pub. Date: Aug. 20, 2020

(54) FLUID SUPPLY DEVICE, INTERNAL STRUCTURE, AND METHOD FOR MANUFACTURING THE SAME

(71) Applicant: SIO CO., LTD., Tokyo (JP)

(72) Inventors: Masuhiko Komazawa, Tokyo (JP); Masaru Ohki, Tokyo (JP); Shin Komazawa, Tokyo (JP)

(21) Appl. No.: 16/780,955

(22) Filed: Feb. 4, 2020

(30) Foreign Application Priority Data
Feb. 14, 2019 (JP) 2019-024232
Oct. 9, 2019 (JP) 2019-186410
Nov. 6, 2019 (JP) 2019-201855

(51) Int. Cl. B01F 5/06; B23Q 11/10; B01F 3/08

(52) U.S. Cl. CPC B01F 5/0672; B23Q 11/10; B01F 2005/0088; B01F 3/0861; B01F 5/0665

(57) ABSTRACT

A fluid supply pipe comprises a tubular body and an internal structure. The tubular body has an inlet through which a fluid flows in and an outlet through which the fluid flows out, and is of a hollow shape having an inner wall surface of a circular cross section. The internal structure is a prismatic shaft having a plurality of lateral faces configured to be housed in and fixed to the tubular body. A plurality of pillars are arranged in a mesh pattern on the lateral faces. A space formed between the plurality of pillars between the lateral faces of the internal structure and the inner wall surface of the tubular body serves as fluid flow paths, and the fluid is given a flow characteristic by passing through the flow paths between the plurality of pillars while the fluid is supplied from the inlet and flows out of the outlet.

### CROSS-REFERENCE TO RELATED APPLICATIONS

This application is based upon and claims the benefit of priority under 35 USC 119 of Japanese Patent Application No. 2019-024232 filed on Feb. 14, 2019, Japanese Patent Application No. 2019-186410 filed on Oct. 9, 2019, and Japanese Patent Application No. 2019-201855 filed on Nov. 6, 2019, the entire disclosures of which are incorporated herein by reference for all purposes.

### BACKGROUND OF THE INVENTION

### 1. Field of the Invention

The present invention relates to a fluid supply device for apparatus that supplies a fluid, and more particularly, to a fluid supply device that imparts a predetermined flow characteristic to a fluid flowing therein. Further, the present invention relates to an internal structure used for a fluid supply device and a method for manufacturing the same. For example, a fluid supply device of the present invention is applicable to a device for supplying a coolant (also referred to as a cooling agent or a machining fluid) of various machine tools such as a machining center, a cutting machine, a drill, and a grinding machine. The present invention is also applicable to a mixer or the like for shearing, stirring, diffusing, and mixing fluids. Furthermore, the present invention can also be applied to a fine bubble generating device that generates fine bubbles (microbubbles on the order of micrometers or ultrafine bubbles on the order of nanometers).

### 2. Description of the Related Art

Conventionally in a machine tool, for example, when machining a workpiece made of a metal into a desired shape, a coolant is supplied to a region where the workpiece and an edge tool come into contact with each other and a surrounding area thereof, thereby cooling down the heat generated during the machining, or removing scraps, shavings, and so on of the workpiece from a machining location. Cutting heat generated by high pressure and frictional resistance at the contact region between the workpiece and the edge tool wears the cutting edge or deteriorates its strength, thereby shortening the service life of a tool such as the cutting tool. In addition, if scraps and the like of the workpiece are not sufficiently removed, such scraps may stick to the cutting edge during the machining, thereby decreasing the machining accuracy. In this case, the coolant reduces the frictional resistance between the tool and the workpiece, as well as eliminates cutting heat and at the same time performs a cleaning action of removing scraps from the surface of the workpiece. To this end, it is preferable for the coolant to have a low coefficient of friction, a high boiling point, and to have a characteristic of good permeability into the contact region between the edge tool and the workpiece.

The present applicant disclosed a fluid supply pipe capable of increasing fluid permeability and lubricity in Japanese Patent No. 6245397 or Japanese Patent No. 6245401. For example, in the case of a water-soluble coolant, such a fluid supply pipe was used to generate fine bubbles so as to lower the surface tension of a fluid, thereby succeeding in increasing the permeability and also enhancing the lubricity of the fluid.

This fluid supply pipe can be applied to various applications that require a supply of fine bubbles.

Furthermore, by using this fluid supply pipe, fluids can be finely sheared, stirred, diffused, and mixed even when a plurality of fluids are mixed.

### PRIOR ART DOCUMENTS

### Patent Document

[Patent Document 1] Japanese Patent No. 6245397

[Patent Document 2] Japanese Patent No. 6245401

However, in the conventional fluid supply device, an internal structure disposed therein is of a special shape, and in particular, an embodiment in which a spiral flow path is formed (by a metalworking process such as cutting, turning, and grinding) through which a fluid flows over a metallic cylindrical shaft requires high precision of metalworking, which has been difficult to realize. Therefore, it takes a long time to manufacture, resulting in an increase in the manufacturing cost.

### SUMMARY OF THE INVENTION

Thus, the present invention is made in consideration of such factors as described above, and is designed to improve a conventional fluid supply device and an internal structure used therein. In particular, it is an object of the present invention to provide a fluid supply device that simplifies a manufacturing process and provides fluid flow characteristics equal to or greater than those of the conventional fluid supply device. Further, it is another object of the present invention to realize an internal structure that can be used for such a fluid supply device and a method for manufacturing the same.

The present invention comprises the following features to solve the problems described above.

In accordance with an embodiment of the present invention, a fluid supply device comprises a hollow tubular body having an inlet through which a fluid flows in and an outlet through which the fluid flows out, the tubular body having an inner wall surface of a circular cross section; and an internal structure configured to be housed in and fixed to the tubular body, the internal structure being a prismatic shaft having a plurality of lateral faces. A plurality of pillars are arranged in a mesh pattern on the lateral faces of the internal structure, a space formed between the plurality of pillars and also between the lateral faces of the internal structure and the inner wall surface of the tubular body serves as fluid flow paths, and the fluid is given a flow characteristic by passing through the flow paths between the plurality of pillars while the fluid is supplied from the inlet of the tubular body and flows out of the outlet.

Further, in accordance with another embodiment, the internal structure that is a prismatic shaft comprises a hollow, a second internal structure is housed in and fixed to the hollow of the internal structure, a plurality of pillars are arranged in a mesh pattern on an outer surface of the second internal structure, a space formed between the plurality of pillars and also between the outer surface of the second internal structure and an inner wall surface of the hollow internal structure serves as fluid flow paths, and the fluid is given a flow characteristic by passing through the flow paths between the plurality of pillars of the second internal structure while the fluid is supplied from the inlet of the tubular body and flows out of the outlet.

An internal structure in accordance with an embodiment of the present invention is configured to be housed in a housing and to impart a flow characteristic to a fluid. The internal structure has a prismatic internal shaft having a plurality of lateral faces, a plurality of pillars are arranged in a mesh pattern on the lateral faces of the internal shaft, a space formed between the plurality of pillars serves as fluid flow paths, and the fluid is given a flow characteristic by passing through the flow paths between the plurality of pillars.

Moreover, in accordance with an internal structure of another embodiment, the prismatic internal shaft comprises a hollow, a second internal shaft is housed in and fixed to the hollow of the internal shaft, a plurality of pillars are arranged in a mesh pattern on an outer surface of the second internal shaft, a space formed between the plurality of pillars and also between the outer surface of the second internal shaft and an inner wall surface of the hollow internal shaft serves as fluid flow paths, and the fluid is given a flow characteristic by passing through the flow paths between the plurality of pillars of the second internal shaft.

In accordance with a method for manufacturing an internal structure of an embodiment of the present invention, the method for manufacturing an internal structure configured to be housed in a housing and to impart a flow characteristic to a fluid, comprises: a step of preparing a cylindrical internal shaft; and a step of forming a plurality of pillars arranged in a mesh pattern with a bottom surface thereof as a lateral face of a prismatic shaft and a top surface thereof as a lateral face of a cylindrical shaft by forming intersecting flow paths with the bottom surface as the lateral face of the prismatic shaft and the top surface as an outer diameter of the cylindrical shaft, for the cylindrical internal shaft.

In accordance with a method for manufacturing an internal structure of another embodiment of the present invention, the method for manufacturing an internal structure configured to be housed in a housing and to impart a flow characteristic to a fluid, comprises: a step of preparing an inner internal shaft; a step of forming a plurality of pillars arranged in a mesh pattern by making intersecting flow paths on an outer surface, for the inner internal shaft; a step of preparing a cylindrical outer internal shaft; a step of forming a hollow cavity in which the inner internal shaft is disposed, for the outer internal shaft; a step of forming a plurality of pillars arranged in a mesh pattern with a bottom surface thereof as a lateral face of a prismatic shaft and a top surface thereof as a lateral face of a cylindrical shaft by forming intersecting flow paths with the bottom surface as the lateral face of the prismatic shaft and the top surface as an outer diameter of the cylindrical shaft, for the cylindrical outer internal shaft; and a step of disposing the inner internal shaft having the plurality of pillars formed thereon in the hollow cavity of the outer internal shaft having the plurality of pillars formed thereon.

In accordance with an internal structure of yet another embodiment of the present invention, an internal structure is configured to be housed in a housing and to impart a flow characteristic to a fluid, and the internal structure is formed by connecting a plurality of the internal structures. Each internal structure is configured such that the internal structure has a prismatic internal shaft having a plurality of lateral faces, a plurality of pillars are arranged in a mesh pattern on the lateral faces of the internal shaft, a space formed between the plurality of pillars serves as fluid flow paths, and the fluid is given a flow characteristic by passing through the flow paths between the plurality of pillars, and the plurality of internal structures are connected to one another with an angle relatively rotated therebetween.

In a method for manufacturing an internal structure of yet another embodiment of the present invention, the method for manufacturing an internal structure configured to be housed in a housing and to impart a flow characteristic to a fluid, comprises: a step of preparing a plurality of pillars each having a mounting foot; a step of preparing a prismatic internal shaft having a plurality of holes formed thereon arranged in a mesh pattern, into which the plurality of pillars are disposed; and a step of arranging and forming the plurality of pillars in a mesh pattern on a surface of the internal shaft by inserting the mounting foot of each pillar into each hole, for the internal shaft.

In a method for manufacturing an internal structure of still another embodiment of the present invention, the method for manufacturing an internal structure configured to be housed in a housing and to impart a flow characteristic to a fluid, comprises: a first step of manufacturing partial internal structures by injection molding; and a second step of combining a plurality of the partial internal structures into one internal structure, wherein the internal structure formed by combining a plurality of the partial internal structures into one is of a prismatic shape having a plurality of lateral faces, and a plurality of pillars are arranged in a mesh pattern on each of the lateral faces.

When a fluid supply device of the present invention is used for supplying a coolant to a machine tool or the like, the fluid collides with pillars or the like while passing through narrow flow paths formed between a plurality of pillars, and is finely sheared, stirred, diffused, and mixed, thereby reducing the viscosity of the fluid inside the fluid supply device. Therefore, when an oil-based coolant is injected into the fluid supply device of the present invention, the reduced viscosity makes it easy for the oil-based coolant to permeate into a workpiece or the blade of a machine tool, thereby improving the cooling performance and cleaning performance. In the case where a water-soluble coolant is used, the surface tension of the fluid is reduced by a large number of fine bubbles generated in the fluid supply device, thereby increasing the permeability and lubricity. As a result, the effect of cooling the heat generated at the region where the tool and the workpiece make contact with each other is greatly increased. In this way, the permeability of the fluid can be improved to increase the cooling effect, the lubricity can be improved, and at the same time machining accuracy can be improved. Further, the effect of cleaning is improved as compared with the prior art due to the vibrations and shocks generated in the process in which generated fine bubbles collide with a tool and a workpiece and disappear. This extends the service life of the tool, such as a cutting blade, and reduces the cost spent for replacement of the tool. In particular, because the fluid supply device of the present invention comprises an internal structure that is a prismatic shaft, a plurality of pillars are arranged in a mesh pattern on each lateral face of the internal structure, the space between the pillars act as flow paths of a fluid (acting as intersecting flow paths), and the fluid is given flow characteristics while passing through the flow paths between the pillars, its construction is simplified.

According to a method for manufacturing an internal structure of the present invention, since a plurality of pillars are formed to have the top surface thereof as an outer surface of a shaft and the bottom surface thereof as a lateral face that is an outer surface of a prismatic shaft by forming intersecting flow paths having the lateral faces of the prismatic shaft as the bottom surface, it is possible to form flow paths capable of effectively generating flow characteristics in a fluid even with a simple manufacturing process. And, when inserting and installing a plurality of pillars into open holes arranged in multiple on the shaft rather than forming them by machining, such as cutting or the like, a metal or a resin, etc., a method for manufacturing an internal structure will not require a machining step, such as complicated cutting of a shaft. Further, it is also possible to injection mold a plurality of partial internal structures, and to combine the plurality of partial internal structures into a single internal structure, and various manufacturing methods may be employed.

The fluid supply device of the present invention can be applied to supplying a coolant in various machine tools such as a machining center, a cutting machine, a drill, and a grinding machine. In addition, the fluid supply device of the present invention can be effectively used in a device for mixing two or more kinds of fluids. The present invention is applicable to a variety of other applications for supplying a fluid. For example, the fluid supply device of the present invention can also be applied to a shower nozzle, a hydroponic device, a decontamination device, and the like. For a shower nozzle, cold or hot water is injected into the fluid supply device to impart predetermined flow characteristics (e.g., by generating fine bubbles) to enhance the effect of cleaning.

For hydroponics, water is injected into the fluid supply device to increase the amount of dissolved oxygen and is discharged. Moreover, in order to remove contaminants, various gases (hydrogen, ozone, oxygen, etc.) are dissolved in a liquid (e.g., water) in addition to air, and further, it can be easily supplied as a liquid (e.g., water) containing a gas that has been made into a fine bubble.

### BRIEF DESCRIPTION OF THE DRAWINGS

The above and further objects and novel features of the present invention will more fully appear from the following detailed description when the same is read in conjunction with the accompanying drawings. It is to be expressly understood, however, that the drawings are for the purpose of illustration only and are not intended to limit the scope of the invention.

Here:

FIG. 1 shows an example of a machining center provided with a fluid supply device of the present invention;

FIG. 2A is an exploded side view of a fluid supply device according to a first embodiment of the present invention;

FIG. 2B is a side see-through view of the fluid supply device according to the first embodiment of the present invention;

FIG. 3 is a three-dimensional (3D) perspective view of an internal structure of the fluid supply device according to the first embodiment of the present invention;

FIG. 4 is a three-dimensional perspective view of the internal structure of the fluid supply device according to the first embodiment of the present invention viewed from another direction;

FIG. 5A illustrates a quadrangular pyramid and an arrangement of pillars on the lateral faces of a quadrangular prism of the internal structure of the fluid supply device, according to the first embodiment of the present invention;

FIG. 5B shows an acute angle of the pillars and an intersecting angle of intersecting flow paths formed by a plurality of pillars in the internal structure of the fluid supply device, according to the first embodiment of the present invention;

FIG. 6A is an exploded side view of a fluid supply device according to a second embodiment of the present invention;

FIG. 6B is a side see-through view of the fluid supply device according to the second embodiment of the present invention;

FIG. 7 is a three-dimensional perspective view of an internal structure of the fluid supply device according to the second embodiment of the present invention;

FIG. 8A illustrates a triangular pyramid and an arrangement of pillars on the lateral faces of a triangular prism of the internal structure of the fluid supply device, according to the second embodiment of the present invention;

FIG. 8B is shows an acute angle of the pillars and an intersecting angle of intersecting flow paths formed by a plurality of pillars in the internal structure of the fluid supply device, according to the second embodiment of the present invention;

FIG. 9A is an exploded side view of a fluid supply device according to a third embodiment of the present invention;

FIG. 9B is a side see-through view of the fluid supply device according to the third embodiment of the present invention;

FIG. 10 is a three-dimensional perspective view of an internal structure of the fluid supply device according to the third embodiment of the present invention during the assembly thereof;

FIG. 11A is a three-dimensional perspective view of the internal structure of the fluid supply device according to the third embodiment of the present invention upon completion of the assembly thereof;

FIG. 11B is a cross-sectional view of the internal structure of the fluid supply device according to the third embodiment of the present invention upon completion of the assembly thereof;

FIG. 12 is a three-dimensional perspective view of the internal structure of the fluid supply device according to the third embodiment of the present invention upon completion of the assembly thereof, viewed from another direction;

FIG. 13A illustrates an arrangement of a plurality of pillars on the lateral faces of a quadrangular prism of an outer internal structure of the fluid supply device, according to the third embodiment of the present invention;

FIG. 13B illustrates a quadrangular pyramid and an arrangement of a plurality of pillars on the lateral faces of a quadrangular prism of an inner internal structure of the fluid supply device, according to the third embodiment of the present invention;

FIG. 14A is an exploded side view of a fluid supply device according to a fourth embodiment of the present invention;

FIG. 14B is a side see-through view of the fluid supply device according to the fourth embodiment of the present invention;

FIG. 15 is a three-dimensional perspective view of an internal structure of the fluid supply device according to the fourth embodiment of the present invention during the assembly thereof;

FIG. 16A is a three-dimensional perspective view of the internal structure of the fluid supply device according to the fourth embodiment of the present invention upon completion of the assembly thereof;

FIG. 16B is a cross-sectional view of the internal structure of the fluid supply device according to the fourth embodiment of the present invention upon completion of the assembly thereof;

FIG. 17 is a three-dimensional perspective view of the internal structure of the fluid supply device according to the fourth embodiment of the present invention upon completion of the assembly thereof, viewed from another direction;

FIG. 18A illustrates an arrangement of a plurality of pillars of an outer internal structure of the fluid supply device according to the fourth embodiment of the present invention;

FIG. 18B illustrates an arrangement of a plurality of pillars of an inner internal structure of the fluid supply device according to the fourth embodiment of the present invention;

FIG. 19A is an exploded side view of a fluid supply device according to a fifth embodiment of the present invention;

FIG. 19B is a side see-through view of the fluid supply device according to the fifth embodiment of the present invention;

FIG. 20 is a three-dimensional perspective view of an internal structure of the fluid supply device according to the fifth embodiment of the present invention during the assembly thereof;

FIG. 21A is a three-dimensional perspective view of the internal structure of the fluid supply device according to the fifth embodiment of the present invention upon completion of the assembly thereof;

FIG. 21B is a cross-sectional view of the internal structure of the fluid supply device according to the fifth embodiment of the present invention upon completion of the assembly thereof;

FIG. 22 illustrates, through planarization, an arrangement of a plurality of pillars on the cylindrical lateral face of an inner internal structure of the fluid supply device according to the fifth embodiment of the present invention;

FIG. 23A is an exploded side view of a fluid supply device according to a sixth embodiment of the present invention;

FIG. 23B is a side see-through view of the fluid supply device according to the sixth embodiment of the present invention;

FIG. 24 is a three-dimensional perspective view of an internal structure of the fluid supply device according to the sixth embodiment of the present invention during the assembly thereof;

FIG. 25A is a three-dimensional perspective view of the internal structure of the fluid supply device according to a sixth embodiment of the present invention upon completion of the assembly thereof;

FIG. 25B is a cross-sectional view of the internal structure of the fluid supply device according to the sixth embodiment of the present invention upon completion of the assembly thereof;

FIG. 26 is a three-dimensional perspective view of the internal structure of the fluid supply device according to the sixth embodiment of the present invention upon completion of the assembly thereof, viewed from another direction;

FIG. 27 is a three-dimensional perspective view of an internal structure of a fluid supply device according to a seventh embodiment of the present invention;

FIG. 28 is a three-dimensional perspective view of the internal structure of the fluid supply device according to the seventh embodiment of the present invention viewed from another direction;

FIG. 29 is a three-dimensional perspective view of an internal structure of a fluid supply device according to an eighth embodiment of the present invention;

FIG. 30A is an exploded side view of a fluid supply device according to a ninth embodiment of the present invention;

FIG. 30B is a side see-through view of the fluid supply device according to the ninth embodiment of the present invention;

FIG. 31 is a three-dimensional perspective view of an internal structure of the fluid supply device according to the ninth embodiment of the present invention;

FIG. 32A illustrates a quadrangular pyramid and an arrangement of pillars on the lateral faces of a quadrangular prism of the internal structure of the fluid supply device, according to the ninth embodiment of the present invention;

FIG. 32B illustrates that the pillars of the internal structure of the fluid supply device according to the ninth embodiment of the present invention are slightly tilted alternately for each row;

FIG. 33A is an exploded side view of a fluid supply device according to a tenth embodiment of the present invention;

FIG. 33B is a side see-through view of the fluid supply device according to the tenth embodiment of the present invention;

FIG. 34 is a three-dimensional perspective view of an internal structure of the fluid supply device according to the tenth embodiment of the present invention;

FIG. 35A illustrates a triangular pyramid and an arrangement of pillars on the lateral faces of a triangular prism of the internal structure of the fluid supply device, according to the tenth embodiment of the present invention;

FIG. 35B illustrates that the pillars of the internal structure of the fluid supply device according to the tenth embodiment of the present invention are slightly tilted alternately for each row;

FIGS. 36 (A) to 36 (H) show a plurality of variations in which uneven features or one or more steps are formed on the lateral faces of a pillar according to the present invention;

FIG. 37 shows a state of mounting a pillar having a mounting foot to one of a plurality of holes arranged in an internal structure of a fluid supply device, according to an eleventh embodiment of the present invention;

FIGS. 38 (A) to 38 (M) show various forms of a pillar having a mounting foot according to the eleventh embodiment;

FIG. 39A shows a fluid supply device comprising an internal structure and a tubular body made of an elastic material according to a twelfth embodiment of the present invention;

FIG. 39B shows a variation of the twelfth embodiment of the present invention, illustrating a fluid supply device comprising an internal structure and a tubular body in which pillars of the internal structure are slightly tilted to the left and right direction from the longitudinal direction of a shaft of an internal shaft;

FIG. 40A shows a fluid supply device having a plurality of internal structures connected to one another according to a thirteenth embodiment of the present invention;

FIG. 40B illustrates that a plurality of internal structures connected to one another and a tubular body are formed of an elastic material according to a variation of the thirteenth embodiment of the present invention;

FIG. 41 shows a process of manufacturing partial internal structures by injection molding according to the fourteenth embodiment of the present invention;

FIG. 42 shows a side view of a ⅓ partial internal structure of an internal structure formed by the manufacturing method according to the fourteenth embodiment of the present invention;

FIG. 43A is a three-dimensional perspective view of the ⅓ partial internal structure according to the fourteenth embodiment of the present invention; and

FIG. 43B is a three-dimensional perspective view of the ⅓ partial internal structure according to the fourteenth embodiment of the present invention, viewed from another angle.

### DETAILED DESCRIPTION OF THE PREFERRED EMBODIMENT

Though, in this specification, embodiments in which the present invention is primarily applied to a machining center or other machine tools (a lathe, a drilling machine, a boring machine, a milling machine, a grinding machine, a turning center, and the like) will be described, applications of the present invention are not limited thereto. The present invention is applicable to various applications for supplying a fluid.

Hereinafter, embodiments of the present invention will be described in greater detail with reference to the drawings.

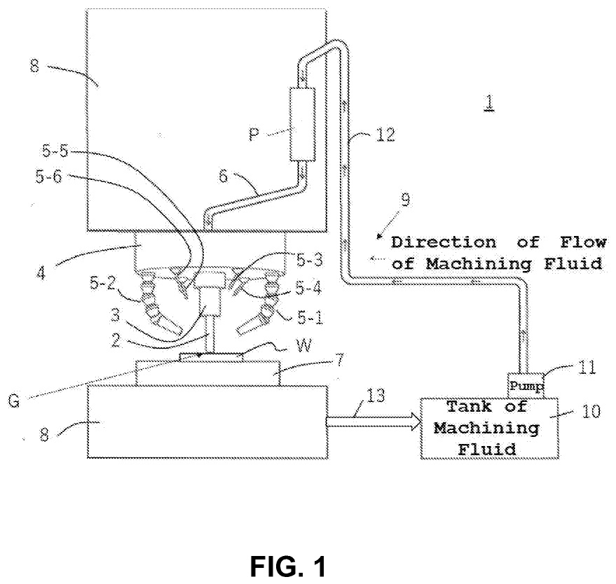

FIG. 1 shows an embodiment of a machining center provided with a fluid supply unit to which the present invention is applied. As shown, the machining center 1 has a number of different kinds of edge tools 2 (tools such as a drill, a milling cutter, an end mill, etc.) interchangeably mounted to a spindle 3. The spindle 3 can rotate the edge tool 2 by a spindle motor which is not shown. There is also a drive unit, not shown, to raise and lower the spindle 3 and the edge tool 2. The machining center 1 allows various operations such as milling, drilling, boring, and tapping to be performed by changing the edge tool 2. In addition to the spindle 3, nozzles 5-1 to 5-6 for supplying a fluid (a coolant or a machining fluid) are also provided in a column 4. The two lock line nozzles 5-1 and 5-2 discharge the fluid supplied through a connecting pipe 6 through the inside of the column 4 toward around a machining location G of a workpiece W. In addition, the machining center 1 also comprises four small single nozzles 5-3 to 5-6, to freely discharge the fluid supplied through the connecting pipe 6 and through the inside of the column 4 at an appropriate discharge angle. These nozzles 5-1 to 5-6 are also mounted to the column 4. Moreover, the machining center 1 comprises a table 7 for moving the workpiece W on a flat surface, a base 8 comprising the column 4 or the like for moving the workpiece W or the edge tool 2 up and down, and a fluid supply unit 9 for supplying the fluid to the edge tool 2 or the workpiece W. The fluid supply unit 9 comprises a machining fluid tank 10 for storing a fluid, a pump 11 for causing the fluid to flow out of the machining fluid tank 10, and a pipe 12 for sending the fluid from the pump 11 to a fluid supply pipe P (the “fluid supply device” of the present invention).

The fluid flowing from the pipe 12 into the fluid supply pipe P is given a predetermined flow characteristic by means of an internal structure of the fluid supply pipe P while passing through the fluid supply pipe P, passes through the connecting pipe 6 via an outlet of the fluid supply pipe P, and is delivered to the nozzles 5-1 to 5-6 described above passing further through the inside of the column 4. The fluid discharged toward the machining location G or the like is collected by a pipe 13 and then returns to the machining fluid tank 10 through filtration or the like by a filter device (not shown). Hereinafter, a variety of embodiments of the fluid supply pipe P (fluid supply pipes 100 to 600, internal structures 740 and 840, fluid supply pipes 900 and 1000) will be described with reference to the drawings.

### First Embodiment

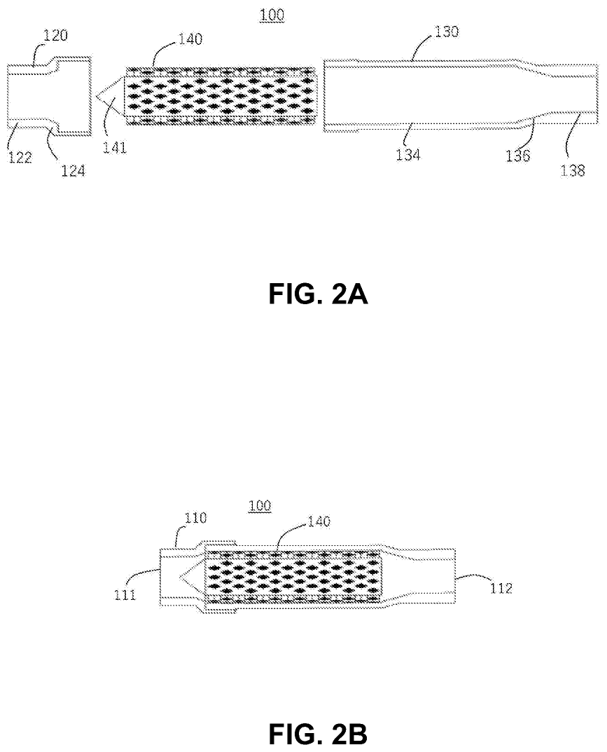

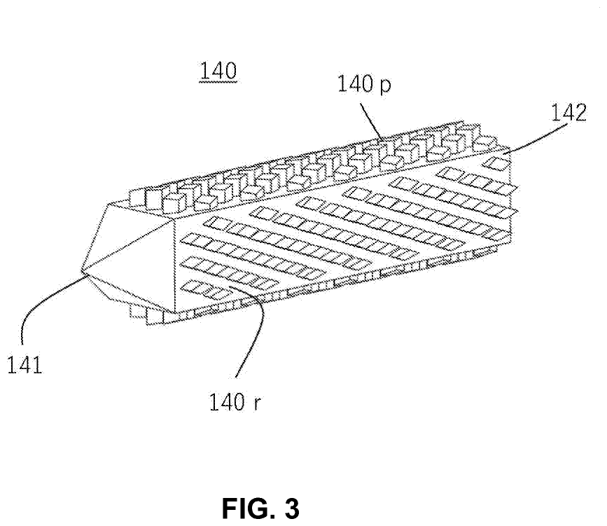

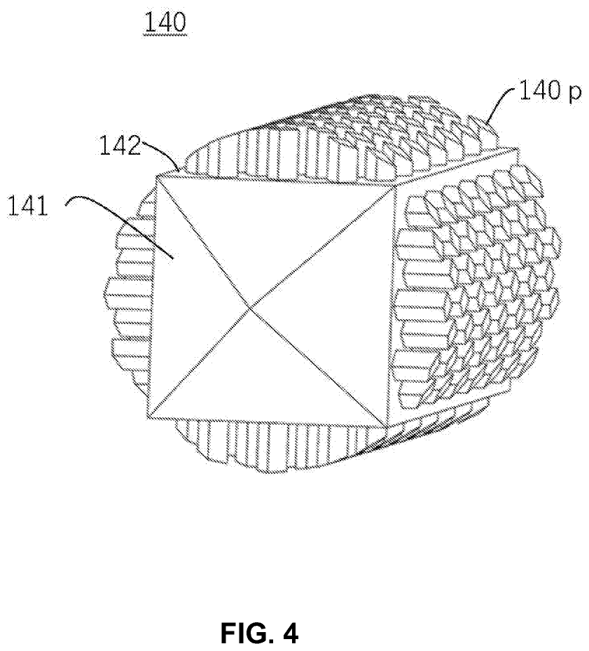

FIG. 2A is an exploded side view of a fluid supply pipe 100 according to a first embodiment of the present invention, and FIG. 2B is a side see-through view of the fluid supply pipe 100. FIG. 3 is a three-dimensional (3D) perspective view of an internal structure 140 of the fluid supply pipe 100, and FIG. 4 is a three-dimensional perspective view of the internal structure 140 from another angle. As shown in FIGS. 2A and 2B, the fluid supply pipe 100 comprises a tubular body 110 and an internal structure 140. In FIG. 2B, a fluid flows from an inlet 111 to an outlet 112 side.

The tubular body 110 comprises an inlet-side member 120 and an outlet-side member 130. The inlet-side member 120 and the outlet-side member 130 have a form of a hollow tube in a cylindrical shape. The inlet-side member 120 has an inlet 111 of a predetermined diameter at one end, and a female thread (not shown) formed by threading an inner peripheral surface at the side of the other end for connection with the outlet-side member 130. A connecting portion 122 is formed on the side of the inlet 111, and the connecting portion 122 is coupled to the pipe 12. For example, with screw connection between the female thread (not shown) formed on the inner peripheral surface of the connecting portion 122 and a male thread (not shown) formed on the outer peripheral surface of an end of the pipe 12, the inlet-side member 120 and the pipe 12 are connected to each other. In the present embodiment, as shown in FIG. 2A, the inlet-side member 120 has different inner diameters at opposite ends, that is, the inner diameter of the inlet 111 (inlet end) is different from that of the outlet end, or the inner diameter at the inlet 111 is smaller than that of the outlet end. A tapered portion 124 (or a step) is formed between the inlet 111 and the outlet end. The present invention is not limited to this construction, and the inlet-side member 120 may have the same inner diameter at both ends of the inlet end and the outlet end.

The outlet-side member 130 has an outlet 112 of a predetermined diameter at one end, and a male thread (not shown) formed by threading the outer peripheral surface at the side of the other end for connection to the inlet-side member 120. The diameter of the outer peripheral surface of the male thread of the outlet-side member 130 is the same as the inner diameter of the female thread of the inlet-side member 120. A connecting portion 138 is formed on the outlet 112 side, and the connecting portion 138 is coupled to the connecting pipe 6. For example, with screw connection between the female thread (not shown) formed on the inner peripheral surface of the connecting portion 138 and the male thread (not shown) formed on the outer peripheral surface of an end of the connecting pipe 6, the outlet-side member 130 and the connecting pipe 6 are connected to each other. A cylindrical portion 134 and a tapered portion 136 (or a step) are formed between the inlet end and the connecting portion 138. In the present embodiment, the outlet-side member 130 has different inner diameters at opposite ends, that is, the inner diameter of the outlet 112 (outlet end) is different from that of the inlet end, and the inner diameter of the outlet 112 is smaller than that of the inlet end. The present invention is not limited to this construction, and the outlet-side member 130 may have the same inner diameter at both ends. By screw connection between the female thread on the inner peripheral surface at one end of the inlet-side member 120 and the male thread on the outer peripheral surface at one end of the outlet-side member 130, the inlet-side member 120 and the outlet-side member 130 are connected to each other, thereby forming the tubular body 110. Meanwhile, the above construction of the tubular body 110 is just one embodiment, and the present invention is not limited to the above construction. For example, connection between the inlet-side member 120 and the outlet-side member 130 is not limited to the screw connection described above, and any method of connecting mechanical parts known to a person skilled in the art may be applied. Further, the shapes of the inlet-side member 120 and the outlet-side member 130 are not limited to the shapes shown in FIG. 2A, and may be arbitrarily selected by a designer or may be changed depending on the purposes of the fluid supply pipe 100. That is, the external shape of the tubular body 110 is not limited to the one shown, and may take various shapes such as a rectangular tube or the like. The inlet-side member 120 or the outlet-side member 130 is made of, for example, a metal such as steel or aluminum, or a resin such as plastic. Referring to FIGS. 2A and 2B together, it will be appreciated that the fluid supply pipe 100 may be configured such that the internal structure 140 is housed in the outlet-side member 130, and then screw connection is achieved between the male thread on the outer peripheral surface of the outlet-side member 130 and the female thread on the inner peripheral surface of the inlet-side member 120.

The internal structure 140 is formed by, for example, a method of performing metalworking on a cylindrical member made of a metal such as steel or aluminum, a method of molding a resin such as plastic, and the like. Alternatively, it may also be possible to use a three-dimensional (3D) printer with a metal or resin. When a metallic cylindrical shaft is machined, a cutting, turning, or grinding process is performed alone or in combination. For example, it is possible to perform cutting by an end mill. The manufacturing process comprises a step of preparing a cylindrical internal shaft, a step of forming one end of the cylindrical internal shaft into a pyramid (a quadrangular pyramid 141 in the case of the first embodiment), and a step of forming a plurality of pillars 140p with the bottom surface thereof being a lateral face of a prism and the top surface thereof being the lateral face of a cylinder by forming intersecting flow paths 140r with the bottom surface being a lateral face of the prism (for the first embodiment, a quadrangular prism 142 whose bottom surface is a square) and the top surface being the outer diameter of the cylinder. It is preferred that the radius of the original cylindrical member is the same as or slightly smaller than that of the inner wall of the tubular body 110, and that the cylindrical member is sized to be housed inside the tubular body leaving no gap therebetween.

As can be seen from FIG. 4, a cylindrical shaft is machined to form the quadrangular pyramid 141 at the leading end, to form the quadrangular prism 142 in the remaining portion thereof, and to form the plurality of pillars 140p on the four lateral faces of the quadrangular prism 142. The plurality of pillars 140p are arranged in a mesh pattern, the bottom surface thereof is the same surface as an outer surface (lateral face) of the quadrangular prism 142, the top surface thereof is the outer surface of the original cylindrical internal shaft, and the plurality of pillars 140p are rounded with a height in the shape of an arc as a whole. That is, when the internal structure 140 is inserted into and fixed to the tubular body 110 as shown in FIG. 2B, the quadrangular pyramid 141 diffuses an inflowing fluid from the center of the circle of the tubular body 110 to the radial direction, and guides the fluid to the four lateral faces of the quadrangular prism 142. Then, the fluid that has reached each lateral face flows through the intersecting flow paths 140r formed between the plurality of pillars 140p, but since the height of the cylindrical inner wall surface of the tubular body 110 and that of the plurality of pillars 140p are substantially the same (no gap therebetween), the fluid will flow through the intersecting flow paths 140r between the plurality of pillars 140p (i.e., there is substantially no flow over the top surfaces of the plurality of pillars 140p).

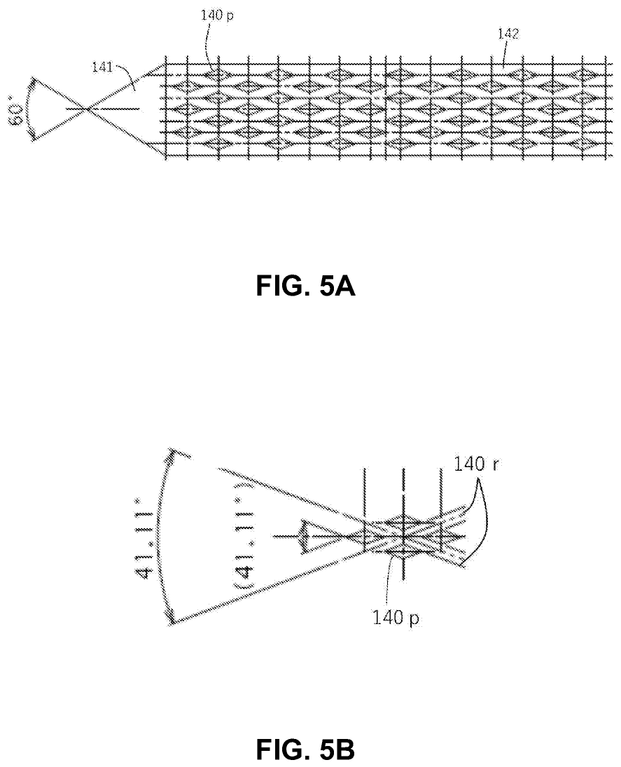

FIG. 5A shows the quadrangular pyramid 141 and the arrangement of the pillars 140p by illustrating one lateral face of the internal structure 140 on a plane, and the apex angle of the quadrangular pyramid 141 on the upstream side is, for example, 60 degrees. Of course, this angle may be changed as appropriate. Further, rhombic (the shape of the bottom) pillars 140p with a vertex angle of 41.11° are formed in a mesh pattern on the four lateral faces of the quadrangular prism 142 on the downstream side. Note that the vertical angle may also be appropriately changed. Therefore, as shown in FIG. 5B, the intersecting angle of the intersecting flow paths 140r formed between the plurality of pillars 140p is also 41.11°. Specifically speaking, the plurality of pillars 140p having a bottom surface of rhombic shape formed on one lateral face are arranged in 14 rows of a sequence of three pillars, four pillars, three pillars, . . . , four pillars from upstream to downstream, and thus there are 49 pillars on one lateral face, resulting in a total of 196 pillars on the four lateral faces. Of course, this number may be changed as appropriate. The shape of the plurality of pillars 140p may be such that the bottom surface of the pillars is not of a rhombic shape (e.g., a triangle, a polygon, or the like), and the arrangement thereof may also be appropriately changed (angle, interval, etc.) from FIGS. 5A and 5B. Such changes may be similarly possible in other embodiments described below.

Hereinafter, the flow of a fluid while passing through the fluid supply pipe 100 will be described. The fluid flowing in through the inlet 111 via the pipe 12 (see FIG. 1) by means of the pump 11 in which an impeller (rotor) rotates clockwise or counterclockwise passes through the space in the tapered portion 124 of the inlet-side member 120, strikes the quadrangular pyramid 141 of the internal structure 140, and is diffused outward from the center of the fluid supply pipe 100 (i.e., in the radial direction and toward the bottom surface of the quadrangular pyramid). The diffused fluid reaches each lateral face of the quadrangular prism 142, and proceeds among narrow intersecting flow paths 140r (intersecting angle of) 41.11° between the plurality of pillars 140p that are formed by the numbers of three, four, three, . . . from the upstream side to the downstream side and that have a bottom of a rhombic shape and a top of a round shape as part of a cylinder. At this time, with regard to the intensity of the flow of the fluid at the intersecting flow paths, from upstream toward downstream in FIG. 5A, the intensity of flow in the direction from the left diagonal upstream side to the right diagonal downstream side is approximately the same as the intensity of flow in the direction from the right diagonal upstream side to the left diagonal downstream side. Note that the angle between these two flow directions is the intersecting angle (41.11°) as described above. The fluid collides with and sheared by the plurality of pillars 140p, and repeats collision, mixing, and dispersion in the plurality of intersecting flow paths 140r. In FIG. 5A, the fluid that has reached the left end (the upper end in FIG. 5A) of the lateral face of the quadrangular prism 142 turns around, that is, from upstream to downstream, the flow that has flowed from the diagonally upstream right to the diagonally downstream left will flow from the diagonally upstream left to the diagonally downstream right, the fluid that has reached the right end (the lower end in FIG. 5A) turns around, that is, from upstream to downstream, and the flow that has flowed from the diagonally upstream left to the diagonally right downstream will flow from the diagonally upstream right to the diagonally downstream left. A large number of small vortices are generated by the fluid passing through the plurality of narrow flow paths 140r formed by the plurality of pillars 140p. Moreover, because of the multi-stage arrangement in a mesh pattern of the plurality of pillars 140p, a flip-flop phenomenon in which a fluid flows alternately to switch to the left and right also occurs at the intersecting flow paths 140r. Such a phenomenon induces mixing and diffusion of the fluid. The structure of the pillars 140p as described above is also useful when mixing two or more fluids having different properties.

The internal structure 140 has a construction to allow the fluid to flow from the upstream side (the quadrangular pyramid 141) having a larger cross-sectional area to the downstream side (the intersecting flow paths 140r formed between the plurality of pillars 140p) having a smaller cross-sectional area. This construction changes the static pressure of the fluid. The relationship between pressure, velocity, and potential energy when no external energy is applied to a fluid is expressed by the following Bernoulli equation:

$$p + \frac{ρ {υ}^{2}}{2} + gh ρ = k$$

where p is the pressure at a point in the streamline, ρ is the density of the fluid, u is the velocity of the flow at that point, g is the gravitational acceleration, h is the height of that point relative to the reference plane, and k is a constant. The Bernoulli theorem expressed as in the above equation is a variation of the law of conservation of energy applied to a fluid, and describes that the sum of all forms of energy on a streamline remains constant for a flowing fluid. According to Bernoulli's theorem, the fluid velocity is low and the static pressure is high on the upstream side where the cross-sectional area is larger. On the other hand, the velocity of the fluid increases and the static pressure decreases on the downstream side where the cross-sectional area is smaller.

If a fluid is a liquid, vaporization of the liquid begins when a reduced static pressure reaches the saturated vapor pressure of the liquid. As such, a phenomenon in which a static pressure becomes lower than its saturated vapor pressure (in the case of water, 3000 to 4000 Pa) within a very short period of time at substantially the same temperature to cause the liquid to evaporate rapidly is called cavitation. The internal structure of the fluid supply pipe 100 of the present invention induces such cavitation phenomenon. This phenomenon is likely to occur in the case of a water-soluble coolant containing water as a main component. By the cavitation phenomenon, the liquid boils with the nuclei of fine bubbles of 100 microns or less existing in the liquid as nuclei, to generate a large number of small bubbles. Fine bubbles generated by vaporization reduce the surface tension of water, thereby improving permeability and lubricity. Improved permeability results in increased cooling efficiency. Alternatively, air or other gas is injected into the fluid in advance (a gas injection unit may be provided in the middle of the pipe 12 in FIG. 1), and the collision of the fluid with the plurality of pillars 140p causes the dissolved gas to be released, so that a large number of fine bubbles may be generated. Also in this case, the generated fine bubbles reduce the surface tension of water, and thus improving permeability and lubricity. Improved permeability results in increased cooling efficiency.

For water, one water molecule can form hydrogen bonds with other four water molecules, and it is not easy to break this hydrogen bond network. Therefore, water has a much higher boiling point and melting point than other liquids that do not form hydrogen bonds, and exhibits high viscosity. Since the property of having a high boiling point of water offers an excellent cooling effect, water is frequently used as cooling water for machining equipment that performs grinding, and the like, but there is a problem that the size of water molecules is large, so that the permeability to a machining location and lubricity are not good. Therefore, a special lubricating oil (i.e., cutting oil) which is usually not water is often used alone or mixed with water. However, if the supply pipe of the present invention is used, vaporization of water occurs due to the cavitation phenomenon described above, and as a result, the hydrogen bond network of water is destroyed, thereby reducing the viscosity thereof. Furthermore, according to the present invention, the machining quality, that is, the performance of the machine tool can be improved even if only water is used without a special lubricating oil.

The fluid that has passed through the plurality of narrow intersecting flow paths 140r on each lateral face of the quadrangular prism 142 of the internal structure 140 flows toward the downstream end of the internal structure 140. At the downstream end, the fluid flows out into the space where the downstream tapered portion 136 of the outlet-side member 130 is located while switching its flow to the left and right direction due to the flip-flop phenomenon. Thereafter, the fluid exits through the outlet 112 and is discharged toward the machining location G or the like through the nozzles 5-1 to 5-6 in FIG. 1. The fluid to be discharged from the nozzles 5-1 to 5-6 is sufficiently sheared, stirred, diffused, and mixed at a fine-level in the fluid supply pipe P (the fluid supply pipe 100 in FIG. 2B), and an oil-based coolant has better lubricity as compared with the original water-soluble coolant, but the viscosity is reduced and the permeability is increased, thereby improving the effect of cooling. In addition, if the fluid contains a large number of fine bubbles (particularly, in the case of a water-soluble coolant) by passing through narrow intersecting flow paths 140r between the plurality of pillars 140p, and by being discharged from the nozzles 5-1 to 5-6, the fluid is exposed to the atmospheric pressure and collides with the edge tool 2 and the workpiece W, so that the bubbles break or burst to disappear. The vibrations and shocks generated in the process of disappearing the bubbles effectively remove sludge and scraps produced at the machining location G. In other words, fine bubbles improve the effect of cleaning around the machining location G while disappearing.

By providing the fluid supply pipe 100 of the present invention in a fluid supply unit of a machine tool or the like, a coolant or a working liquid is supplied as a fluid having a sufficient discharge force from a nozzle, so as to cool down the heat generated at the edge tool and workpiece more effectively than before and to improve the permeability and lubricity, thereby enhancing machining accuracy. Furthermore, by effectively removing scraps of the workpiece from the machining location, the service life of a tool such as a cutting blade and the like can be extended, thereby reducing the cost spent for replacement of a tool.

In the present embodiment, since one cylindrical member is machined to form the quadrangular pyramid 141 and the quadrangular prism 142 provided with the plurality of pillars 140p in a mesh pattern (the intersecting flow paths 140r therebetween) of the internal structure 140, the internal structure 140 is manufactured as one integral part. Therefore, the fluid supply pipe 100 can be manufactured by just a simple process of receiving the internal structure 140 inside the outlet-side member 130, and then coupling the outlet-side member 130 and the inlet-side member 120 (e.g., by screw connection) to each other. Although the quadrangular pyramid 141 is provided at the upstream portion of the internal structure 140 for efficiently dispersing the inflowing fluid to each lateral face, such a feature is not an essential construction. The internal structure 140 may just need a plurality of pillars 140p formed in a mesh pattern on the lateral faces of the quadrangular prism 142. Moreover, although the downstream end of the internal structure 140 is the bottom surface (rectangle or square) of the quadrangular prism 142, a quadrangular pyramid may be provided at this downstream end to direct the fluid to the center of the outlet 112 of the tubular body 110. The same applies to other embodiments described below.

In the fluid supply device of the present embodiment, in particular, since the intersecting flow paths 140r are formed on the lateral faces of the prism (the quadrangular prism 142 in the present embodiment), that is, on a planar surface, high accuracy is not required and the manufacturing is simple. It is possible for the fluid supply device to provide at least one flow characteristic in relation to whether to (i) generate a large number of fine bubbles, (ii) mix a plurality of fluids, or (iii) stir and diffuse a fluid, while the fluid flows through the flow paths between the pillars. As a result, in addition to the machining center, the present invention can be used for supplying a coolant and a machining fluid to various machine tools such as various lathes, drilling machines, boring machines, milling machines, grinding machines, turning centers, and the like. The present invention can also be effectively used for a device for mixing two or more fluids (liquid and liquid, liquid and gas, or gas and gas, and the like). Further, when the fluid supply device is applied to a combustion engine, the fuel and the air are sufficiently mixed to improve the combustion efficiency. Further, when the fluid supply device is applied to a cleaning device, the effect of cleaning can be further improved as compared with a common cleaning device. In addition, the fluid supply device of the present invention is useful in various applications including removal of contaminants, by generating fine bubbles containing air, hydrogen, oxygen, ozone, and other gases. These functions can also be similarly realized in other embodiments described below.

### Second Embodiment

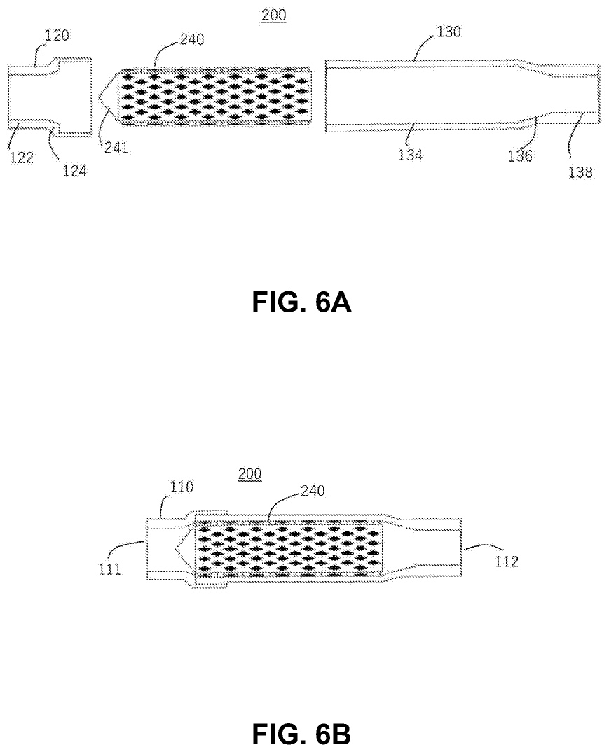

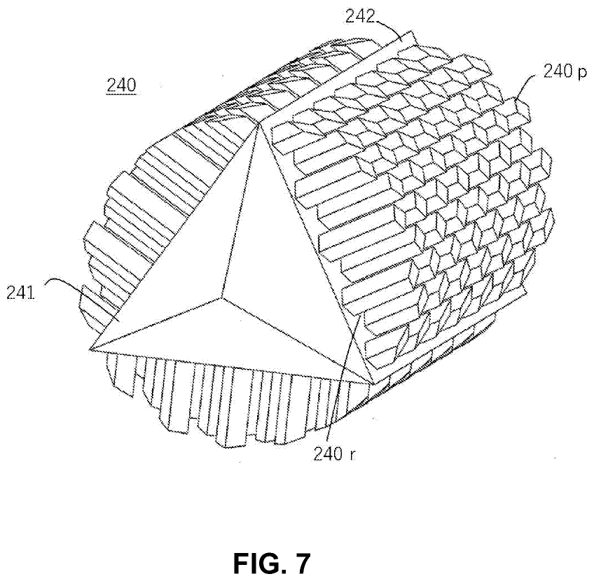

Next, a fluid supply pipe 200 according to a second embodiment of the present invention will be described with reference to FIGS. 6A to 8B. The description of the same features as those of the first embodiment will not be repeated, and the different features will be described in greater detail. The same reference numerals and symbols will be used for the same components as those of the first embodiment. FIG. 6A is an exploded side view of the fluid supply pipe 200 according to the second embodiment, and FIG. 6B is a side see-through view of the fluid supply pipe 200. As shown in FIGS. 6A and 6B, the fluid supply pipe 200 includes a tubular body 110 and an internal structure 240. FIG. 7 is a three-dimensional perspective view of the internal structure 240. Since the tubular body 110 of the second embodiment is the same as that of the first embodiment, the description is not repeated. In FIG. 6B, a fluid flows from an inlet 111 to an outlet 112 side. As shown in FIG. 6B, the fluid supply device 200 is constructed by receiving the internal structure 240 inside the outlet-side member 130, followed by coupling a male thread on the outer peripheral surface of an outlet-side member 130 and a female thread on the inner peripheral surface of an inlet-side member 120 to each other.

As in the first embodiment, the internal structure 240 is formed by, for example, a method of performing metalworking on a cylindrical member made of a metal such as steel or aluminum, a method of molding a resin such as plastic, and the like. Alternatively, it may also be possible to use a 3D printer with a metal or resin. When a metallic cylindrical shaft is machined, a cutting, turning, or grinding process is performed alone or in combination. For example, it is possible to perform cutting by an end mill. The process comprises a step of preparing a cylindrical internal shaft, a step of forming one end of the cylindrical internal shaft into a triangular pyramid 241, and a step of forming a plurality of pillars 240p with the bottom surface thereof being a lateral face of the triangular prism 242 and the top surface thereof being the lateral face of the cylinder by forming intersecting flow paths 240r with the bottom surface being a lateral face of the triangular prism 242 and the top surface being the outer diameter of the cylinder. Note that the bottom surface of the triangular prism 242 is an equilateral triangle.

As shown in FIG. 7, a cylindrical shaft is machined to form the triangular pyramid 241 at the leading end, to form the triangular prism 242 in the remaining portion thereof, and to form the plurality of pillars 240p on three lateral faces of the triangular prism 242. The plurality of pillars 240p are arranged in a mesh pattern, the bottom surface thereof is the same surface as the outer surface (lateral face) of the triangular prism 242, the top surface thereof is the outer surface of the original cylindrical internal shaft, and the plurality of pillars 240p are rounded with a height in the shape of an arc as a whole. That is, when the internal structure 240 is inserted into and fixed to the tubular body 110 as shown in FIG. 6B, the triangular pyramid 241 diffuses and guides an inflowing fluid from the center of the circle of the tubular body 110 to each lateral face of the triangular prism 242. Then, the fluid that has reached each lateral face flows through the intersecting flow paths 240r formed between the plurality of pillars 240p, but since the height of the cylindrical inner wall surface of the tubular body 110 and that of the plurality of pillars 240p are substantially the same (there is no gap therebetween), the fluid will flow through the narrow intersecting flow paths 240r between the plurality of pillars 240p (i.e., almost no fluid flows on the top surfaces of the plurality of pillars 240p).

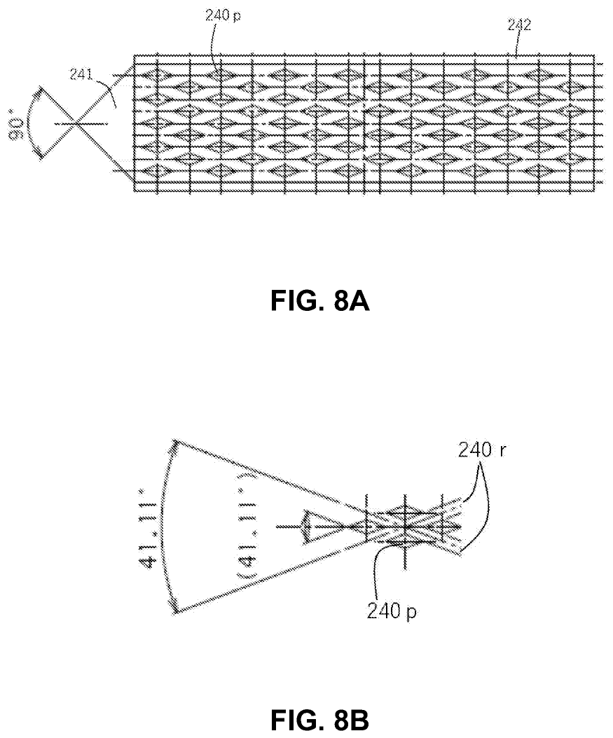

FIG. 8A shows the triangular pyramid 241 and the arrangement of the plurality of pillars 240p by illustrating one lateral face of the internal structure 240 on a plane, and the apex angle of the triangular pyramid 241 on the upstream side is, for example, 90 degrees. Of course, this angle may be changed as appropriate. Further, rhombic (the shape of the bottom) pillars 240p with a vertex angle of 41.11° are formed in a mesh pattern on the three lateral faces of the triangular prism 242 on the downstream side. Note that the vertex angle may also be appropriately changed. Therefore, as shown in FIG. 8B, the intersecting angle of the intersecting flow paths 240r formed between the plurality of pillars 240p is also 41.11°. Specifically speaking, the plurality of pillars 240p having a bottom surface of rhombic shape formed on one lateral face are arranged in 14 rows of a sequence of five pillars, four pillars, five pillars, . . . , four pillars from upstream to downstream, and thus there are 63 pillars on one lateral face, resulting in a total 189 pillars on the three lateral faces. Of course, this number may be changed as appropriate. As in the first embodiment, the shape of the plurality of pillars 240p may be such that the bottom surface of the pillars is not of a rhombic shape (e.g., a triangle, a polygon, or the like), and the arrangement thereof may also be appropriately changed (angle, interval, etc.) from FIGS. 8A and 8B.

Hereinafter, the flow of a fluid while passing through the fluid supply pipe 200 will be described. The fluid flowing in through the inlet 111 passes through the space in the tapered portion 124 of the inlet-side member 120, strikes the triangular pyramid 241 of the internal structure 240, and is diffused outward from the center of the fluid supply pipe 200 (i.e., in the radial direction and toward the bottom surface of the triangular pyramid 241). The diffused fluid reaches each lateral face of the triangular prism 242, and proceeds among narrow intersecting flow paths 240r (intersecting angle of 41.11°) between the pillars 240p that are formed by the numbers five, four, five, . . . from the upstream side to the downstream side and that have a bottom of a rhombic shape and a top of a round shape as part of a cylinder. From upstream to downstream in FIG. 8A, the intensity of flow in the direction from the diagonally upstream left to the diagonally downstream right is substantially the same as the intensity of flow in the direction from the diagonally upstream right to the diagonally downstream left. The fluid collides with and sheared by the plurality of pillars 240p, and repeats collision, mixing, and dispersion in the plurality of intersecting flow paths 240r. Also in the present embodiment, the flow turns around from the left and right ends (upper and lower ends, respectively, in FIG. 8A) of the lateral face of the triangular prism 242 in FIG. 8A. A large number of small vortices are generated by the fluid passing through the plurality of narrow flow paths 240r formed by the plurality of pillars 240p. Moreover, because of the multi-stage arrangement in a mesh pattern of the plurality of pillars 240p, a flip-flop phenomenon in which a fluid flows alternately to switch to the left and right also occurs at the intersecting flow paths 240r. Such a phenomenon induces mixing and diffusion of the fluid. The structure of the pillars 240p as described above is also useful when mixing two or more fluids having different properties.

Further, the internal structure 240 has a construction to allow the fluid to flow from the upstream side (the triangular pyramid 241) having a larger cross-sectional area to the downstream side (the intersecting flow paths 240r formed between the plurality of pillars 240p) having a smaller cross-sectional area. As described in the first embodiment, the static pressure is reduced according to Bernoulli's equation, and by the cavitation phenomenon, the liquid boils with the nuclei of fine bubbles of 100 microns or less existing in the liquid as nuclei, to generate a large number of small bubbles. Fine bubbles generated by vaporization reduce the surface tension of water, thereby improving permeability and lubricity. Alternatively, air or other gas is injected into the fluid in advance (a gas injection unit may be provided in the middle of the pipe 12 in FIG. 1), and the collision of the fluid with the plurality of pillars 240p causes the dissolved gas to be released, so that a large number of fine bubbles may be generated.

The fluid that has passed through the plurality of narrow intersecting flow paths 240r on each lateral face of the triangular prism 242 of the internal structure 240 flows toward the end of the internal structure 240. At the downstream end, the fluid flows out into the space where the tapered portion 136 downstream of the outlet-side member 130 is provided while switching its flow to the left and right direction due to the flip-flop phenomenon. Thereafter, the fluid exits through the outlet 112 and is discharged toward the machining location G or the like through the nozzles 5-1 to 5-6 in FIG. 1.

In addition, although the triangular pyramid 241 is provided at the upstream portion of the internal structure 240 for efficiently dispersing the inflowing fluid to each lateral face, such a feature is not an essential construction. The internal structure 240 may just need a plurality of pillars 240p formed in a mesh pattern on the lateral faces of the triangular prism 242. Moreover, although the downstream end of the internal structure 240 is the bottom surface (triangle) of the triangular prism 242, a triangular pyramid may be provided at this downstream end to direct the fluid to the center of outlet 112 of tubular body 110. The same applies to other embodiments described below.

### Third Embodiment

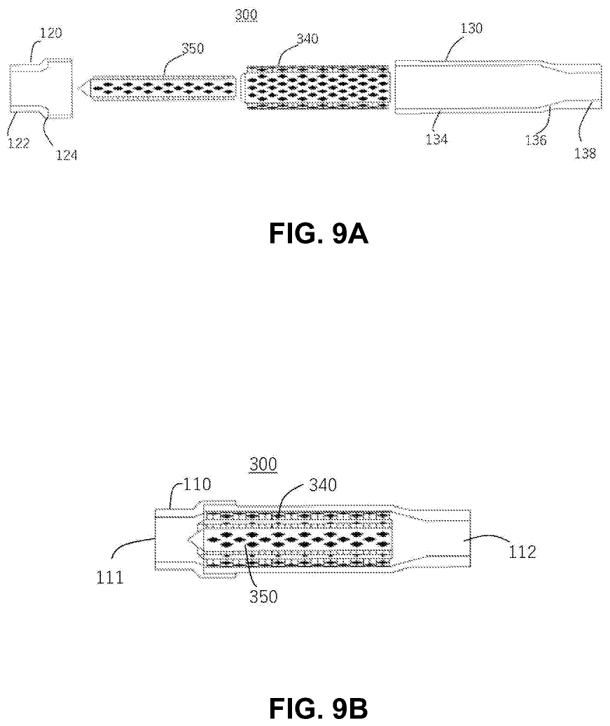

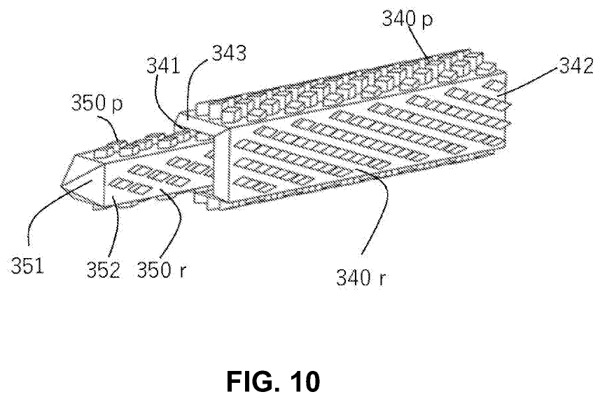

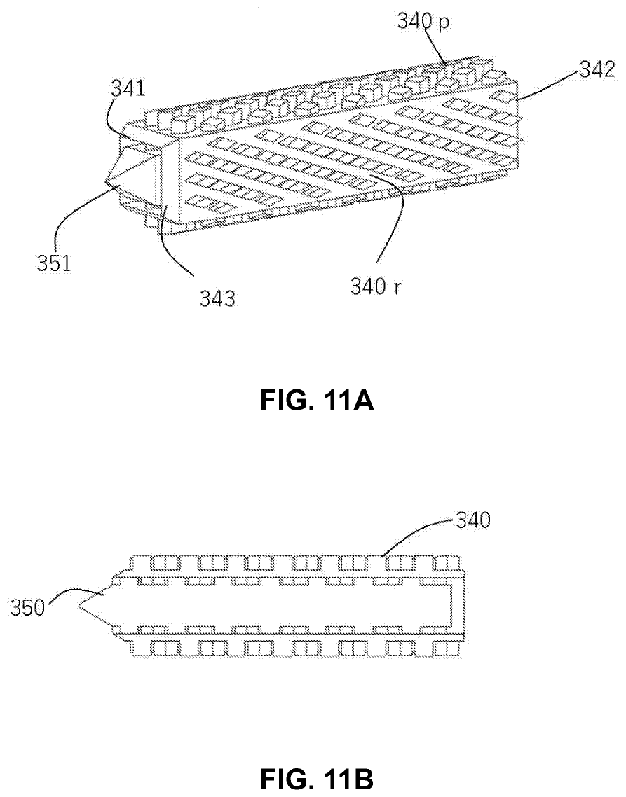

Next, a fluid supply pipe 300 according to a third embodiment of the present invention will be described with reference to FIGS. 9A to 13B. In the present embodiment, the description of the same features as those of the first embodiment will not be repeated, and the different features will be described in greater detail. The same reference numerals and symbols will be used for the same components as those of the first embodiment. FIG. 9A is an exploded side view of the fluid supply pipe 300 according to the third embodiment, and FIG. 9B is a side see-through view of the fluid supply pipe 300. As shown in FIGS. 9A and 9B, the fluid supply pipe 300 comprises a tubular body 110, a first internal structure (outer internal structure) 340, and a second internal structure (inner internal structure) 350. The internal structure 340 is of a quadrangular prism 342 the same as that of the first embodiment, but has a hollow cavity 341 in the form of a rectangular parallelepiped formed therein, and the second internal structure 350 is housed in the cavity 341. FIG. 10 is a three-dimensional perspective view showing a state where the second internal structure 350 is being received in the internal structure 340. FIG. 11A is a three-dimensional perspective view showing a state where the second internal structure 350 is housed in the internal structure 340, and FIG. 11B is a partial cross-sectional view thereof. As in the first embodiment, the first and second internal structures 340 and 350 are formed by, for example, a method of performing metalworking on a columnar member made of a metal such as steel or aluminum, a method of molding a resin such as plastic, and the like. Alternatively, it may also be possible to use a 3D printer with a metal or resin. When a metallic cylindrical shaft is machined, a cutting, turning, or grinding process is performed alone or in combination. For example, it is possible to perform cutting by an end mill. The process comprises a step of preparing an inner internal shaft having an outer shape of a prism (a quadrangular prism in the third embodiment), a step of forming a quadrangular pyramid 351 at an upstream end of the inner internal shaft, and a step of forming a plurality of pillars 350p by making intersecting flow paths 350r on the outer surfaces of the inner internal shaft (more specifically, forming the plurality of pillars 350p with the bottom surface thereof being the same height as the bottom surface of the intersecting flow paths 350r and the top surface being the same as the height of lateral faces of the quadrangular prism by forming the intersecting flow paths 350r of a predetermined depth from the lateral faces of the quadrangular prism). In this way, the inner internal structure 350 is formed. And the process further comprises a step of preparing a cylindrical outer internal shaft, a step of forming a hollow cavity 341 in the form of a prism (a quadrangular prism or a rectangular parallelepiped with a square bottom surface in the third embodiment) through the outer internal shaft in which the inner internal shaft is disposed (a tapered guide 343 may be provided on the four sides of the entrance thereof if necessary), and a step of forming a plurality of pillars 340p with the bottom surface thereof being a lateral face of the prism and the top surface thereof being the lateral face of s cylinder by forming intersecting flow paths 340r with the bottom surface being a lateral face of the prism (the quadrangular prism 342 in the third embodiment) and the top surface being the outer diameter of the cylinder, for the cylindrical outer internal shaft. In this way, the outer internal structure 340 is formed. A process of disposing the inner internal structure 350 having the plurality of pillars 350p formed thereon in the hollow cavity 341 of the outer internal structure 340 having the plurality of pillars 340p formed thereon achieves the assembly thereof.

As shown in FIGS. 10 to 12, a cylindrical shaft is machined to form the quadrangular prism 342 on the outer internal structure 340 and to form the plurality of pillars 340p on four lateral faces of the quadrangular prism 342. The plurality of pillars 340p are arranged in a mesh pattern, the bottom surface thereof is the same surface as the outer surface (lateral face) of the quadrangular prism 342, the top surface thereof is the outer surface of the original cylindrical internal shaft, and the plurality of pillars 340p are rounded with a height in the shape of an arc as a whole. And the outer internal structure 340 has the cavity 341 in the form of a rectangular parallelepiped formed therethrough, and the tapered guide 343 is formed on the four sides of the entrance thereof.

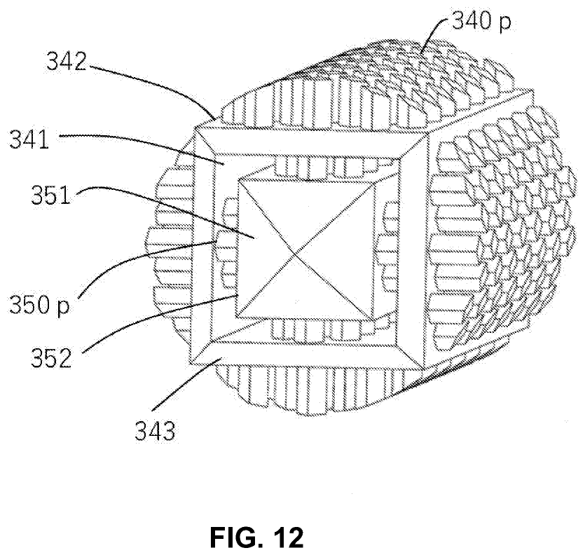

The inner internal structure 350 has the quadrangular pyramid 351 on the inflow side of the fluid, and the remaining portion extended from there is of the shape of the quadrangular prism 352 having the plurality of pillars 350p formed on the four lateral faces. The plurality of pillars 350p are arranged in a mesh pattern, and the height thereof is constant. That is, the top surface of the pillars 350p is fixed at a position equal to or slightly lower (smaller) than the height (or width) of the inner wall of the cavity 341 in the form of a rectangular parallelepiped formed on the outer internal structure 340. (See FIG. 12). In other words, the vertical and horizontal widths of the cavity 341 (the length of each side of the square in cross section) is set to be equal to or slightly greater than the distance between the surfaces of the pillars 350p projecting from the parallel lateral faces of the inner internal structure 350, and accordingly, the distance between the pillars 350p and the wall surface of the cavity 341 is substantially non-existent. As shown in FIGS. 11A, 11B or 12, when the inner internal structure 350 is inserted into the outer internal structure 340 and then further inserted into and fixed to the tubular body 110 as shown in FIG. 9B, the rectangular pyramid 351 diffuses and guides an inflowing fluid from the center of the circle of the tubular body 110 to each lateral face of the quadrangular prism 352. In addition, the tapered guides 343 formed on the four sides of the entrance of the cavity 341 of the internal structure 340 direct the fluid to each lateral face of the quadrangular prism 342. That is, in the third embodiment, the fluid flowing in through the inlet 111 of the tubular body 110 is divided into two flows, one of which enters the cavity 341 through the quadrangular pyramid 351 and passes through the intersecting flow paths 350r formed on the inner internal structure 350 and the other of which passes through the flow paths 340r formed on the outer internal structure 340 directly from the inlet 111 or by way of the quadrangular pyramid 351 and the guides 343, and then the divided flows merge at respective downstream ends to head toward the outlet 112.

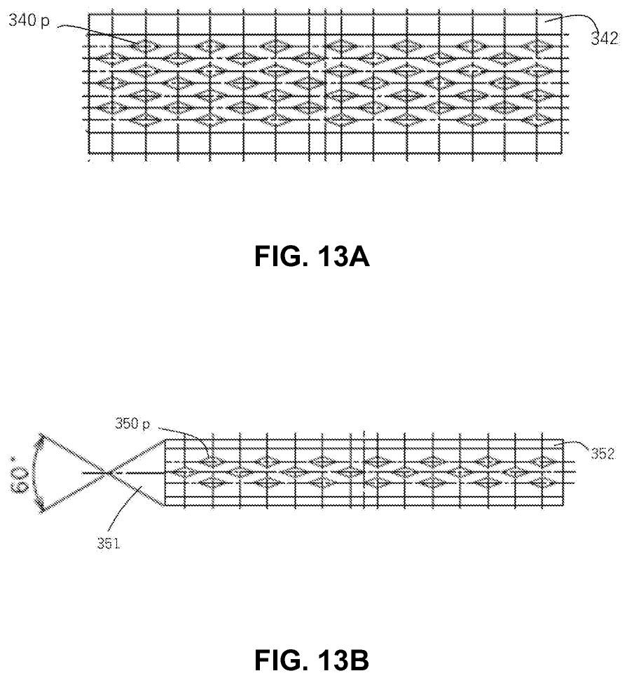

FIG. 13A shows the arrangement of the plurality of pillars 340p by illustrating one lateral face of the internal structure 340 on a plane, and the rhombic (the shape of the bottom) pillars 340p with a vertex angle of 41.11° are formed in a mesh pattern on the four lateral faces of the quadrangular prism 342, though not shown, as in the first embodiment. Further, the vertex angle may be changed as appropriate. Therefore, the intersecting angle of the intersecting flow paths 340r formed between the plurality of pillars 340p is also 41.11°. Specifically speaking, the plurality of pillars 340p having a bottom surface of rhombic shape formed on one lateral face are arranged in 14 rows of a sequence of three pillars, four pillars, three pillars, . . . , four pillars from upstream to downstream, and thus there are 49 pillars on one lateral face, resulting in a total of 196 pillars on the four lateral faces. Of course, this number may also be changed as appropriate. As in the first embodiment, the shape of the plurality of pillars 340p may be such that the bottom surface of the pillars is not of a rhombic shape (e.g., a triangle, a polygon, or the like), and the arrangement thereof may be appropriately changed (angle, interval, etc.) from FIG. 13A.

FIG. 13B shows, on a plane, the quadrangular pyramid 351 upstream of the inner internal structure 350 and the arrangement of the plurality of pillars 350p on one lateral face of the quadrangular prism 352. The quadrangular pyramid 351 on the upstream side has an apex angle of, for example, 60 degrees. Of course, this angle may be changed as appropriate. And on the downstream side thereof, the rhombic (the shape of the bottom) pillars 350p with a vertex angle of 41.11° are formed in a mesh pattern on the four lateral faces of the quadrangular prism 352, though not shown, similarly to the outer internal structure 340. Further, the vertex angle may be changed as appropriate. Therefore, the intersecting angle of the intersecting flow paths 350r formed between the plurality of pillars 350p is also 41.11°. Specifically speaking, the plurality of pillars 350p having a bottom surface of rhombic shape formed on one lateral face are arranged in 14 rows of a sequence of one pillar, two pillars, one pillar, . . . , two pillars from the upstream side, and thus there are 21 pillars on one lateral face, resulting in a total of 84 pillars on the four lateral faces. Of course, this number may also be changed as appropriate. Similarly to the pillars 340p of the outer internal structure 340, the shape of the plurality of pillars 350p may be such that the bottom surface of the pillars is not of a rhombic shape (e.g., a triangle, a polygon, or the like), and the arrangement thereof may be appropriately changed (angle, interval, etc.) from FIG. 13B.

Hereinafter, the flow of a fluid while passing through the fluid supply pipe 300 will be described. The fluid flowing in through the inlet 111 passes through the space in the tapered portion 124 of the inlet-side member 120, strikes the quadrangular pyramid 351 of the internal structure 350, and is diffused outward from the center of the fluid supply pipe 300 (i.e., in the radial direction and toward the bottom surface of the quadrangular pyramid), where part of the fluid flows into the inner intersecting flow paths 350r formed by the inner internal structure 350 and the cavity 341. Further, the remainder of the fluid is guided by the guides 343 on the four sides of the internal structure 340, to flow into the intersecting flow paths 340r formed inside by the outer internal structure 340 and the tubular body 110. For the fluid flowing into the intersecting flow paths 340r between the plurality of pillars 340p in FIG. 13A and the intersecting flow paths 350r between the plurality of pillars 350p in FIG. 13B, the intensity of flow in the direction from the diagonally upstream left to the diagonally downstream right is substantially the same as the intensity of flow in the direction from the diagonally upstream right to the diagonally downstream left, from the upstream to the downstream side. Also in the present embodiment, the flow turns around from the left and right ends (the respective upper and lower ends in FIG. 13A) of the lateral face of the quadrangular prism 342 in FIG. 13A. On the other hand, as shown in FIG. 12, since each side (respectively, upper and lower ends in FIG. 13B) of the lateral faces of the quadrangular prism 352 of the inner internal structure 350 is at a certain distance from each side of the lateral faces of the rectangular parallelepiped of the cavity 341, the fluid may move from a flow path on one lateral face to a flow path on another lateral face at the upper and lower ends of the lateral faces of the quadrangular prism 352.

By the fluid passing through the plurality of narrow flow paths 340r formed by the plurality of pillars 340p of the outer internal structure 340 and passing through the plurality of narrow flow paths 350r formed by the plurality of pillars 350p of the inner internal structure 350, a large number of small vortices are generated. Moreover, the fluid collides with and sheared by the plurality of pillars 340p, and repeats collision, mixing, and dispersion in the plurality of intersecting flow paths 340r in the outer internal structure 340. In the inner internal structure 350, the fluid collides with and sheared by the plurality of pillars 350p, and repeats collision, mixing, and dispersion in the plurality of intersecting flow paths 350r. Furthermore, because of the multi-stage arrangement in a mesh pattern of the plurality of pillars 340p and 350p, a flip-flop phenomenon in which a fluid flows alternately to switch to the left and right also occurs at the intersecting flow paths 340r and 350r. Such a phenomenon induces mixing and diffusion of the fluid. The structure of the pillars 340p, 350p as described above is also useful when mixing two or more fluids having different properties.

In addition, the internal structures 340 and 350 have a construction to allow the fluid to flow from the upstream side (the quadrangular pyramid 351) having a larger cross-sectional area to the downstream side (the intersecting flow paths 340r formed between the plurality of pillars 340p and the intersecting flow paths 350r formed between the plurality of pillars 350p) having a smaller cross-sectional area. As described in the first embodiment, the static pressure is reduced according to Bernoulli's equation, and by the cavitation phenomenon, the liquid boils with the nuclei of fine bubbles of 100 microns or less existing in the liquid as nuclei, to generate a large number of small bubbles. Fine bubbles generated by vaporization reduce the surface tension of water, thereby improving permeability and lubricity. Alternatively, air or other gas is injected into the fluid in advance (a gas injection unit may be provided in the middle of the pipe 12 in FIG. 1), and the collision of the fluid with the plurality of pillars 340p and 350p causes the dissolved gas to be released, so that a large number of fine bubbles may be generated.

The fluid that has passed through the plurality of narrow intersecting flow paths 340r on each lateral face of the quadrangular prism 342 of the internal structure 340 flows toward the end of the internal structure 340. In addition, the fluid that has passed through the plurality of narrow intersecting flow paths 350r on each lateral face of the quadrangular prism 352 of the internal structure 350 flows toward the end of the internal structure 350. At respective downstream ends, the fluid flows out into and merges in the space where the tapered portion 136 downstream of the outlet-side member 130 is provided while switching its flow to the left and right direction due to the flip-flop phenomenon. Thereafter, the fluid exits through the outlet 112 and is discharged toward the machining location G or the like through the nozzles 5-1 to 5-6 in FIG. 1.

In addition, although the quadrangular pyramid 351 is provided at the upstream portion of the internal structure 350 for efficiently dispersing the inflowing fluid to each lateral face, such a feature is not an essential construction. The internal structure 350 may just need a plurality of pillars 350p formed in a mesh pattern shape on the lateral faces of the quadrangular prism 352. Moreover, although the downstream end of the internal structure 350 is the bottom surface (a square) of the quadrangular prism 352, a quadrangular pyramid may be provided at this downstream end so as to partially project from the exit of the cavity 341, thereby directing the fluid to the center of the outlet 112 of the tubular body 110. In addition, although the cavity 341 of the outer internal structure 340 of the third embodiment is configured as a rectangular parallelepiped, it may also be possible to configure the cavity 341 in a cylindrical shape, whereas the inner internal structure 350 may be provided with a plurality of pillars arranged in a mesh pattern having a surface in an arc shape from the bottom surface of the quadrangular prism. That is, it may also be possible to form pillars having varying heights in the shape of an arc, similar to the pillars 340p of the outer internal structure 340.

### Fourth Embodiment

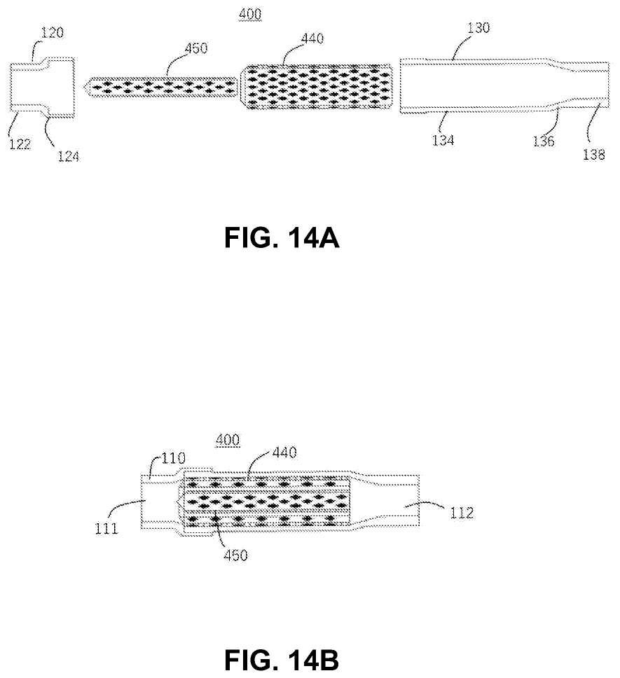

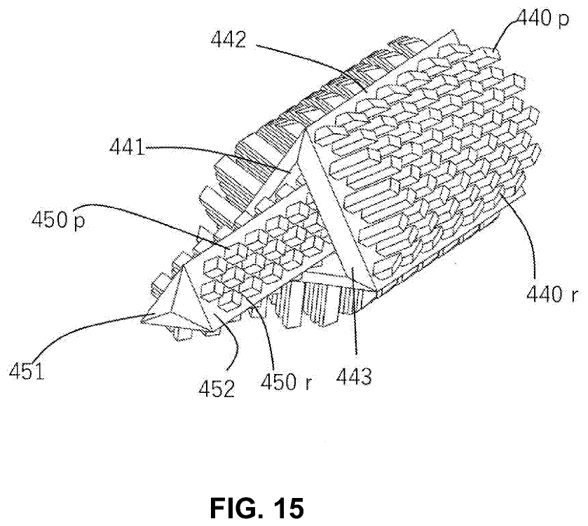

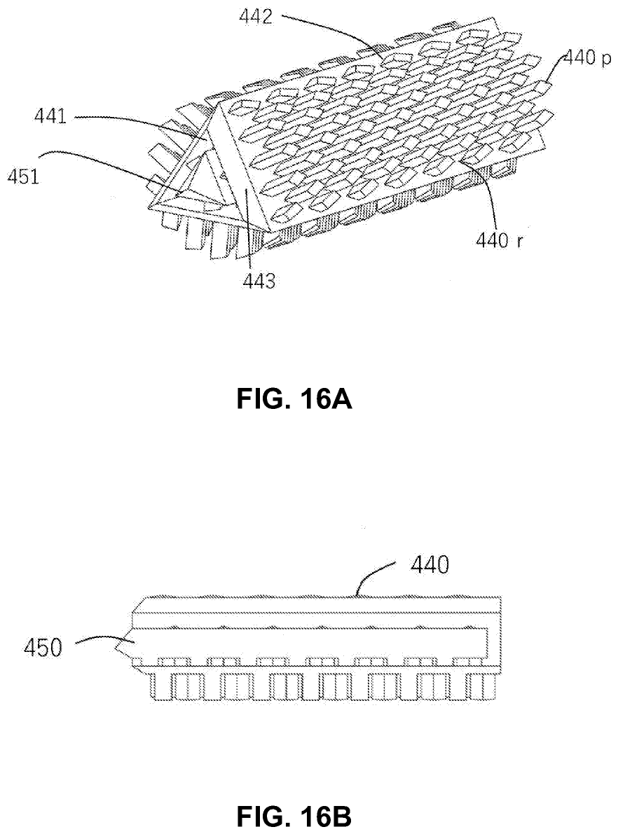

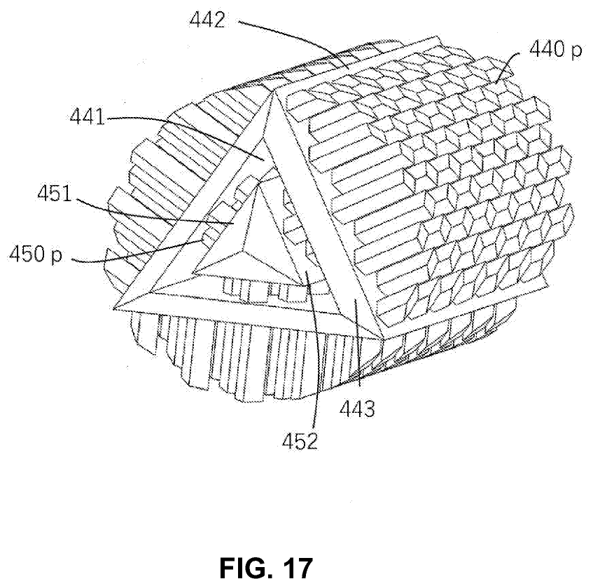

Next, a fluid supply pipe 400 according to a fourth embodiment of the present invention will be described with reference to FIGS. 14A to 18B. In the present embodiment, the description of the same features as those of the second or third embodiment will not be repeated, and the different features will be described in greater detail. The same reference numerals and symbols will be used for the same components as those of the third embodiment. FIG. 14A is an exploded side view of the fluid supply pipe 400 according to the fourth embodiment, and FIG. 14B is a side see-through view of the fluid supply pipe 400. As shown in FIGS. 14A and 14B, the fluid supply pipe 400 comprises a tubular body 110, a first internal structure (outside internal structure) 440, and a second internal structure (inner internal structure) 450. The internal structure 440 is of a triangular prism 442 (the bottom surface is of an equilateral triangle) similar to the second embodiment but has a hollow cavity 441 in the shape of a triangular prism (the bottom surface is of an equilateral triangle and the length of each side is shorter than the triangle of the bottom surface of the triangular prism 442) formed therethrough, and the second internal structure 450 is housed in this cavity 441. FIG. 15 is a three-dimensional perspective view showing a state where the second internal structure 450 is being received in the internal structure 440. FIG. 16A is a three-dimensional perspective view showing a state in which the second internal structure 450 is housed in the internal structure 440, and FIG. 16B is a partial cross-sectional view thereof. FIG. 17 is a three-dimensional perspective view showing a state in which the second internal structure 450 is housed in the internal structure 440 viewed from another angle.

As in the third embodiment, the first and second internal structures 440 and 450 are formed by, for example, a method of performing metalworking on a columnar member made of a metal such as steel or aluminum, a method of molding a resin such as plastic, and the like. Alternatively, it may also be possible to use a 3D printer with a metal or resin. When a metallic cylindrical shaft is machined, a cutting, turning, or grinding process is performed alone or in combination. For example, it is possible to perform cutting by an end mill. The manufacturing process comprises a step of preparing an inner internal shaft having an outer shape of a triangular prism, a step of forming a triangular pyramid at an upstream end of the inner internal shaft, and a step forming a plurality of pillars 450p by making intersecting flow paths 450r on the outer surfaces of the inner internal shaft (specifically, forming the plurality of pillars 450p with the bottom surface thereof being the same height as the bottom surface of intersecting flow paths and the top surface thereof being the same as the height of lateral faces of the triangular prism by forming the intersecting flow paths 450r of a predetermined depth from the lateral faces of the triangular prism). In this way, the inner internal structure 450 is formed. And the process further comprises a step of preparing a cylindrical outer internal shaft, a step of forming a hollow cavity 441 in the form of a triangular prism through the outer internal shaft in which the inner internal shaft is disposed, and a step of forming a plurality of pillars 440p with the bottom surface thereof being a lateral face of the triangular prism and the top surface thereof being the lateral face of the cylinder by forming intersecting flow paths 440r with the bottom surface being a lateral face of the triangular prism and the top surface being the outer diameter of the cylinder, with respect to the cylindrical outer internal shaft. In this way, the outer internal structure 440 is formed. A process of disposing the inner internal structure 450 having the plurality of pillars 450p and the intersecting flow paths 450r formed thereon in the hollow cavity 441 of the outer internal structure 440 having the plurality of pillars 440p and the intersecting flow paths 440r formed thereon achieves the assembly thereof.

As shown in FIGS. 15 to 17, a cylindrical shaft is machined to form the triangular prism 442 on the outer internal structure 440 and to form the plurality of pillars 440p on three lateral faces of the triangular prism 442. The plurality of pillars 440p are arranged in a mesh pattern, the bottom surface thereof is the same surface as the outer surface (lateral face) of the triangular prism 442, the top surface thereof is the outer surface of the original cylindrical internal shaft, and the plurality of pillars 440p are rounded with a height in the shape of an arc as a whole. And the outer internal structure 440 has the cavity 441 in the form of a triangular prism formed therethrough, and the tapered guide 443 is formed on the three sides of the entrance thereof.

On the other hand, the inner internal structure 450 has the triangular pyramid 451 on the inflow side of the fluid, and the remaining portion extended from there is the shape of the triangular prism 452 (the bottom surface is an equilateral triangle and the length of each side is shorter than that of the triangular prism 442 of the outer internal structure 440) having the plurality of pillars 450p formed on three lateral faces. The plurality of pillars 450p are arranged in a mesh pattern, and the height thereof is constant. That is, the top surface of the pillars 450p is fixed at a position equal to or slightly lower than the height of the inner wall of the hollow cavity 441 in the form of a triangular prism formed on the outer internal structure 440 (see FIG. 17). As shown in FIG. 16A, 16B or FIG. 17, when the internal structure 450 is inserted into the internal structure 440 and then further inserted into and fixed to the tubular body 110 as shown in FIG. 14B, the triangular pyramid 451 diffuses and guides an inflowing fluid from the center of the circle of the tubular body 110 to each lateral face of the triangular prism 452. In addition, the tapered guides 443 formed on the three sides of the entrance of the internal structure 440 direct the fluid to each lateral face of the triangular prism 442. That is, in the fourth embodiment, the fluid flowing in through the inlet 111 of the tubular body 110 is divided into two flows, one of which enters the cavity 441 through the triangular pyramid 451 and passes through the intersecting flow paths 450r formed on the inner internal structure 450 disposed in the cavity 441 and the other of which passes through the flow paths 440r formed on the outer internal structure 440 directly from the inlet 111 or by way of the triangular pyramid 451 and the guides 443, and then the divided flows merge at respective downstream ends to head toward the outlet 112.

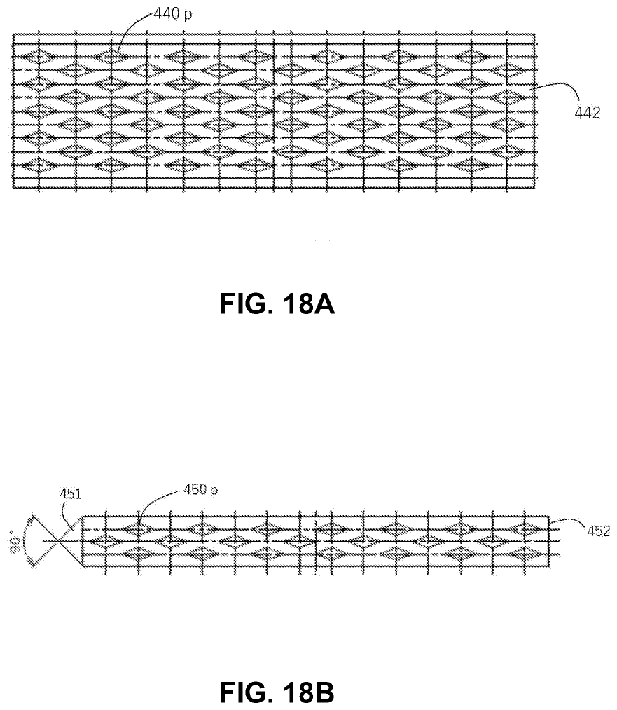

FIG. 18A shows the arrangement of the pillars 440p by illustrating one lateral face of the internal structure 440 on a plane, and the rhombic (the shape of the bottom) pillars 440p with a vertex angle of 41.11° are formed in a mesh pattern, though not shown, as in the first to third embodiments. Further, the vertex angle may be changed as appropriate. Therefore, the intersecting angle of the intersecting flow paths 440r formed between the plurality of pillars 440p is also 41.11°. Specifically speaking, the plurality of pillars 440p having a bottom surface of rhombic shape formed on one lateral face are arranged in 14 rows of a sequence of five pillars, four pillars, five pillars, . . . , four pillars from upstream to downstream, and thus there are 63 pillars on one lateral face, resulting in a total of 189 pillars on the three lateral faces. Of course, this number may also be changed as appropriate. As in the first to third embodiments, the shape of the plurality of pillars 440p may be such that the bottom surface of the pillars is not of a rhombic shape (e.g., a triangle, a polygon, or the like), and the arrangement thereof may be appropriately changed (angle, interval, etc.) from FIG. 18A.

FIG. 18B shows, on a plane, the triangular pyramid 451 on the upstream side of the internal structure 450 and the arrangement of the pillars 450p on one lateral face of the triangular prism 452 on the downstream side thereof. The triangular pyramid 451 has an apex angle of, for example, 90 degrees, but this angle may be appropriately changed. Although not shown, the rhombic (the shape of the bottom) pillars 450p with a vertex angle of 41.11° are formed in a mesh pattern on the three lateral faces of the triangular prism 452, similarly to the plurality of pillars 440p of the triangular prism 442 of the internal structure 440. Further, the vertex angle may also be appropriately changed. Therefore, the intersecting angle of the intersecting flow paths 450r formed between the plurality of pillars 450p is also 41.11°. Specifically speaking, the plurality of pillars 450p having a bottom surface of rhombic shape formed on one lateral face are arranged in 14 rows of a sequence of one pillar, two pillars, one pillar, . . . , two pillars from upstream to downstream, and thus there are 21 on one lateral face, resulting in a total of 63 pillars on the three lateral faces. Of course, this number may also be changed as appropriate. Similarly to the plurality of pillars 440p on the triangular prism 442 of the internal structure 440, the shape of the plurality of pillars 450p may be such that the bottom surface of the pillars is not of a rhombic shape (e.g., a triangle, a polygon, or the like), and the arrangement thereof may also be appropriately changed (angle, interval, etc.) from FIG. 18B.

Hereinafter, the flow of a fluid while passing through the fluid supply pipe 400 will be described. The fluid flowing in through the inlet 111 passes through the space in the tapered portion 124 of the inlet-side member 120, strikes the triangular pyramid 451 of the internal structure 450, and is diffused outwards from the center of the fluid supply pipe 400 (i.e., in the radial direction and toward the bottom surface of the triangular pyramid), where part of the fluid flows into the intersecting flow paths 450r formed inside by the inner internal structure 450 and the hollow cavity 441 in the shape of a triangular prism. Further, the remainder of the fluid is guided by the guides 443 on the three sides of the internal structure 440, to flow into the intersecting flow paths 440r formed inside by the outer internal structure 440 and the tubular body 110. For the fluid flowing into the intersecting flow paths 440r between the plurality of pillars 440p in FIG. 18A and the intersecting flow paths 450r between the plurality of pillars 450p in FIG. 18B, the intensity of flow in the direction from the diagonally upstream left to the diagonally downstream right is substantially the same as the intensity of flow in the direction from the diagonally upstream right to the diagonally downstream left, from the upstream to the downstream side. Also in the present embodiment, the flow turns around from the left and right ends (upper and lower ends, respectively, in FIG. 18A) of the lateral face of the triangular prism 442 in FIG. 18A. Moreover, as shown in FIG. 17, since each side (respectively, upper and lower ends in FIG. 18B) of the lateral faces of the triangular prism 452 of the inner internal structure 450 is at a certain distance from each side of the lateral faces of the cavity 441 of the triangular prism, the fluid may move from a flow path on one lateral face to a flow path on another lateral face at the upper and lower ends of the lateral faces of the triangular prism 452.

By the fluid passing through the plurality of narrow flow paths 440r formed by the plurality of pillars 440p of the outer internal structure 440 and passing through the plurality of narrow flow paths 450r formed by the plurality of pillars 450p of the inner internal structure 450, a large number of small vortices are generated. Furthermore, the fluid collides with and sheared by the plurality of pillars 440p, and repeats collision, mixing, and dispersion in the plurality of intersecting flow paths 440r in the outer internal structure 440. In the inner internal structure 450, the fluid collides with and sheared by the plurality of pillars 450p, and repeats collision, mixing, and dispersion in the plurality of intersecting flow paths 450r. Moreover, because of the multi-stage arrangement in a mesh pattern of the plurality of pillars 440p and 450p, a flip-flop phenomenon in which a fluid flows alternately to switch to the left and right also occurs at the intersecting flow paths 440r and 450r. Such a phenomenon induces mixing and diffusion of the fluid. The structure of the pillars 440p and 450p as described above is also useful when mixing two or more fluids having different properties.

In addition, the internal structures 440 and 450 have a construction to allow the fluid to flow from the upstream side (the triangular pyramid 451) having a larger cross-sectional area to the downstream side (the intersecting flow paths 440r formed between the plurality of pillars 440p and the intersecting flow paths 450r formed between the plurality of pillars 450p) having a smaller cross-sectional area. As described in the first embodiment, the static pressure is reduced according to Bernoulli's equation, and by the cavitation phenomenon, the liquid boils with the nuclei of fine bubbles of 100 microns or less existing in the liquid as nuclei, to generate a large number of small bubbles. Fine bubbles generated by vaporization reduce the surface tension of water, thereby improving permeability and lubricity.

Alternatively, air or other gas is injected into the fluid in advance (a gas injection unit is provided in the middle of the pipe 12 in FIG. 1), and the collision of the fluid with the plurality of pillars 440p and 450p causes the dissolved gas to be released, so that a large number of fine bubbles may be generated.

The fluid that has passed through the plurality of narrow intersecting flow paths 440r on each lateral face of the triangular prism 442 of the internal structure 440 flows toward the end of the internal structure 440. In addition, the fluid that has passed through the plurality of narrow intersecting flow paths 450r on each lateral face of the triangular prism 452 of the internal structure 450 flows toward the end of the internal structure 450. At respective downstream ends, the fluid flows out into and merges in the space where the tapered portion 136 downstream of the outlet-side member 130 is provided while switching its flow to the left and right direction due to the flip-flop phenomenon. Thereafter, the fluid exits through the outlet 112 and is discharged toward the machining location G or the like through the nozzles 5-1 to 5-6 in FIG. 1.

In addition, although the triangular pyramid 451 is provided at the upstream portion of the internal structure 450 for efficiently dispersing the inflowing fluid to each lateral face, such a feature is not an essential construction. The internal structure 450 may just need a plurality of pillars 450p formed the shape of a net on the lateral faces of the triangular prism 452. Moreover, although the downstream end of the internal structure 450 is the bottom surface (an equilateral triangle) of the triangular prism 452, a triangular pyramid may be provided at this downstream end so as to partially project from the exit of the cavity 441, thereby directing the fluid to the center of the outlet 112 of the tubular body 110. In addition, although the cavity 441 of the outer internal structure 440 of the fourth embodiment is configured as a shape of a hollow triangular prism (a regular polygon in cross section), it may also be possible to configure the cavity 441 in a cylindrical shape, whereas the inner internal structure 450 may be provided with a plurality of pillars arranged in a mesh pattern having a surface in an arc shape from the bottom surface of the triangular prism. That is, it may also be possible to form pillars having varying heights in the shape of an arc, similar to the pillars 440p of the outer internal structure 440.

### Fifth Embodiment

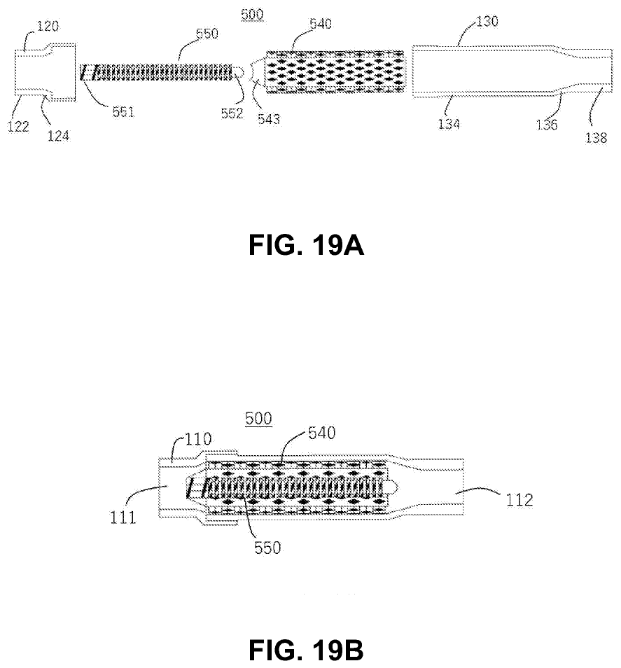

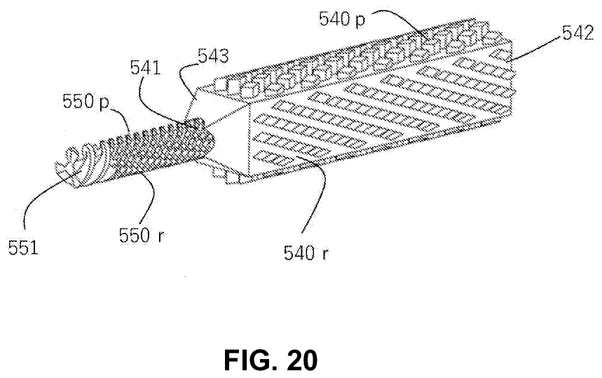

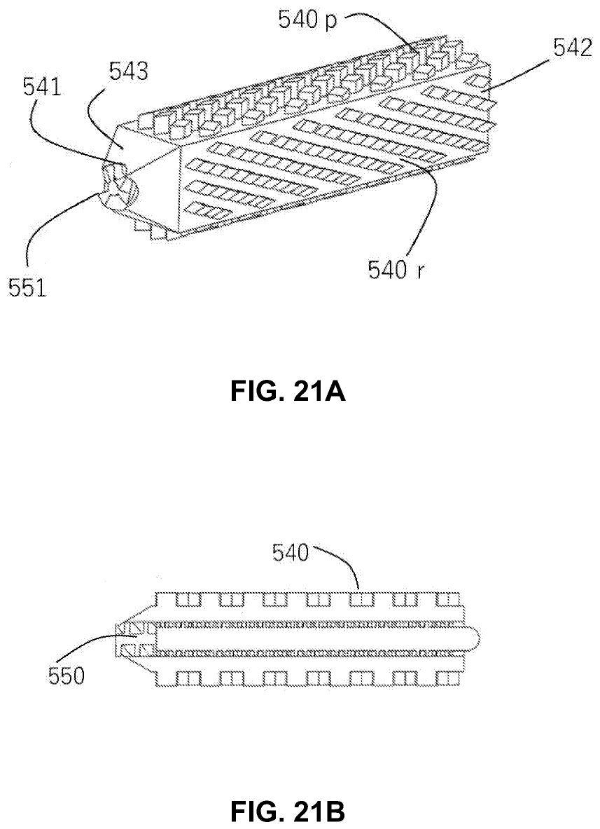

Next, a fluid supply pipe 500 according to a fifth embodiment of the present invention will be described with reference to FIGS. 19A to 22. In the present embodiment, the description of the same features as those of the third embodiment will not be repeated, and the different features will be described in greater detail. The same reference numerals and symbols will be used for the same components as those of the third embodiment. FIG. 19A is an exploded side view of the fluid supply pipe 500 according to the fifth embodiment, and FIG. 19B is a side see-through view of the fluid supply pipe 500. As shown in FIGS. 19A and 19B, the fluid supply pipe 500 comprises a tubular body 110, a first internal structure (outer internal structure) 540, and a second internal structure (inner internal structure) 550. The internal structure 540 comprises a quadrangular prism 542 (the bottom surface is of a square) the same as in the third embodiment, but has a cylindrical hollow cavity 541 formed therethrough, and the second internal structure 550 is housed in this cavity 541. This outer internal structure 540 has a truncated quadrangular pyramid 543 formed by cutting off the head of the quadrangular pyramid as a leading end. More specifically speaking, as shown in FIG. 19A, the cutout has a circular cross section. FIG. 20 is a three-dimensional perspective view showing a state where the second internal structure 550 is being received in the internal structure 540. FIG. 21A is a three-dimensional perspective view showing a state in which the second internal structure 550 is housed in the internal structure 540, and FIG. 21B is a partial cross-sectional view thereof.

As in the third embodiment, the first and second internal structures 540 and 550 are formed by, for example, a method of performing metalworking on a columnar member made of a metal such as steel or aluminum, or a method of molding a resin such as plastic, and the like. Alternatively, it may also be possible to use a 3D printer with a metal or resin. When a metallic cylindrical shaft is machined, a cutting, turning, or grinding process is performed alone or in combination. For example, it is possible to perform cutting by an end mill. The manufacturing process comprises a step of preparing an inner internal shaft having an outer shape of a cylinder, a step of forming one or more blades 551 in a spiral shape (e.g., counterclockwise rotation) at an upstream end of the inner internal shaft, a step of forming a plurality of pillars 550p with the bottom surface thereof being the same height as the bottom surface of intersecting flow paths and the top surface thereof being the same as the height of the lateral face of the cylinder by forming the intersecting flow paths 550r of a predetermined depth from the lateral face of the cylinder on the outer surface downstream of the inner internal shaft, and a step of forming a guiding portion 552 in a dome shape or conical shape at the downstream end of the inner internal shaft, and the inner internal structure 550 is formed through these steps. In a more specific example, the plurality of pillars 550p are formed by forming a plurality of annular and spiral (e.g., counterclockwise rotation) intersecting flow paths 550r as the intersecting flow paths. And the outer internal structure 540 is produced by a step of preparing a cylindrical outer internal shaft, a step of making the upstream side of the outer internal shaft into a truncated quadrangular pyramid 543, a step of forming a hollow cylindrical cavity 541 (having a circular entrance) through the outer internal shaft in which the inner internal shaft is disposed, and a step of forming a plurality of pillars 540p with the bottom surface thereof being a lateral face of the prism and the top surface thereof being the lateral face of the cylinder by forming intersecting flow path 540r with the bottom surface being a lateral face of the prism (the quadrangular prism 542 in the fifth embodiment) and the top surface being the outer diameter of the cylinder, with respect to the cylindrical outer internal shaft. Further, the bottom surface of the quadrangular prism 542 is a square. The two internal structures 540 and 550 may be assembled together by a process of disposing the inner internal structure 550 having the plurality of pillars 550p and the plurality of spiral flow paths 550r formed thereon in the hollow cavity 541 of the outer internal structure 540 having the plurality of pillars 540p and the plurality of spiral flow paths 540r formed thereon.

As shown in FIGS. 20 to 21B, a cylindrical shaft is machined to form the truncated quadrangular pyramid 543 at the leading end, to form the quadrangular prism 542 on the downstream side of the outer internal structure 540, and to form the plurality of pillars 540p on four lateral faces of the quadrangular prism 542. The plurality of pillars 540p are arranged in a mesh pattern, the bottom surface thereof is the same as the lateral face (outer surface) of the quadrangular prism 542, the top surface thereof is the outer surface of the original cylindrical internal shaft, and the plurality of pillars 540p are rounded with a height in the shape of an arc as a whole. The arrangement of the plurality of pillars 540p is the same as that described in the third embodiment. The hollow cylindrical cavity 541 is formed through the outer internal structure 540 from the circular leading end of the truncated quadrangular pyramid 543 to the inside thereof. On the other hand, the inner internal structure 550 has, for example, three spiral blades 551 (which produces a counterclockwise swirling flow) on the inlet-side of the fluid, and the portion extended therefrom is of a cylindrical shape on which the plurality of intersecting flow paths 550r and the plurality of pillars 550p are formed. The plurality of pillars 550p are arranged in a mesh pattern, and the height thereof is constant. That is, the top surface of the pillars 550p is fixed at a position equal to or slightly lower than the height of the inner wall of the cavity 541 formed in the outer internal structure 540 (see FIGS. 19B and 21B). That is, as shown in FIGS. 21A and 21B, when the inner internal structure 550 is inserted into the outer internal structure 540 and then further inserted into and fixed to the tubular body 110 as shown in FIG. 19B, the truncated quadrangular pyramid 543 diffuses and guides part of the inflowing fluid from the center of the circle of the tubular body 110 having a circular cross-section to each lateral face of the outer internal structure 540 of the quadrangular prism 542, and the fluid flowing into each lateral face passes through the intersecting flow paths 540r. The remainder of the inflowing fluid flows from the circular inlet of the truncated quadrangular pyramid 543 into the hollow cavity 541, and is turned into a counterclockwise spiral flow by the blades 551, and then passes through the flow paths 550r of the inner internal structure 550. That is, in the fifth embodiment, the fluid flowing in from the inlet 111 of the tubular body 110 is divided into two flows, one of which passes through the intersecting flow paths 550r formed on the inner internal structure 550 and the other of which passes through the flow paths 540r formed on the outer internal structure 540, and then the divided flows merge at the respective downstream ends to head toward the outlet 112.

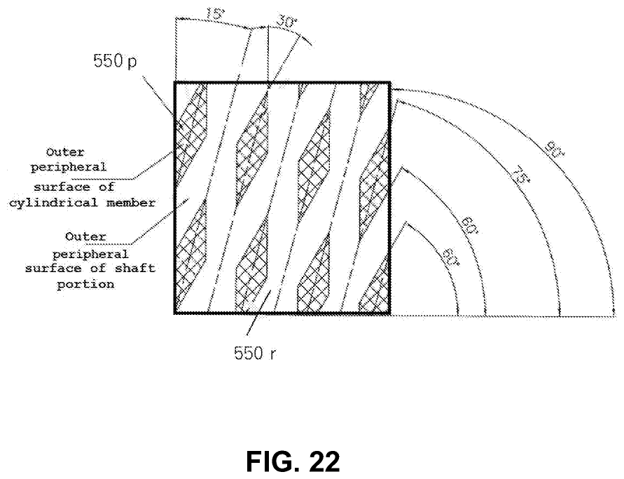

FIG. 22 illustrates in a planarized manner the relationship between the flow paths 550r and pillars 550p (the top surface of the pillars 550p has part of a curved surface of a cylinder, but is of a substantially rhombic shape when viewed from directly above) formed in a cylindrical shape of the inner internal structure 550. One group of the intersecting flow paths is a plurality of spiral flow paths that have an angle of 60 degrees from the lower left to the upper right in FIG. 22 and that create a counterclockwise spiral flow. The other group is a plurality of annular flow paths that create a counterclockwise annular flow that is orthogonal to the fluid flow. The intersecting flow paths 550r where the spiral flow paths and the annular flow paths intersect each other are formed. Further, the shape of the plurality of pillars 550p does not have to be substantially rhombic pillars (e.g., a triangle, a polygon, or the like), and the arrangement thereof can be appropriately changed (angle, interval, etc.) from FIG. 22.

Hereinafter, the flow of a fluid while passing through the fluid supply pipe 500 will be described. The fluid flowing in through the inlet 111 passes through the space in the tapered portion 124 of the inlet-side member 120, strikes the truncated quadrangular pyramid 543 of the internal structure 540, where part of the fluid is directed outward from the center of the circle of the fluid supply pipe 500 having a circular cross-section (i.e., in the radial direction and in the direction toward the bottom surface of the quadrangular pyramid 543) and flows into the intersecting flow paths 540r formed inside by the outer internal structure 540 and the tubular body 110. The remainder of the fluid passes through the blades 551 that create a spiral flow from the circular opening of the truncated quadrangular pyramid 543, and then flows as a spiral flow into the intersecting flow paths 550r formed inside by the inner internal structure 550 and the hollow cylindrical cavity 541.

By the fluid passing through the plurality of narrow flow paths 540r formed by the plurality of pillars 540p of the outer internal structure 540 and passing through the plurality of narrow flow paths 550r formed by the plurality of pillars 550p of the inner internal structure 550, a large number of small vortices are generated. Moreover, the fluid collides with and sheared by the plurality of pillars 540p, and repeats collision, mixing, and dispersion in the plurality of intersecting flow paths 540r in the outer internal structure 540. Likewise, the fluid collides with and sheared by the plurality of pillars 550p, and repeats collision, mixing, and dispersion in the plurality of intersecting flow paths 550r also in the inner internal structure 550. Furthermore, in the outer internal structure 540, because of the multi-stage arrangement in a mesh pattern of the plurality of pillars 540p, a flip-flop phenomenon in which a fluid flows alternately to switch to the left and right also occurs in the intersecting flow path 550r. Such a phenomenon induces mixing and diffusion of the fluid. The structure of the pillars 540p and 550p as described above is also useful when mixing two or more fluids having different properties.

Moreover, the internal structures 540 and 550 have a construction to allow the fluid to flow from the upstream side (the truncated quadrangular pyramid 543 having the circular inlet) having a larger cross-sectional area to the downstream side (the intersecting flow paths 540r formed between the plurality of pillars 540p and the intersecting flow paths 550r formed between the plurality of pillars 550p) having a smaller cross-sectional area. This construction changes the static pressure of the fluid. As described in the first embodiment, the static pressure is reduced according to Bernoulli's equation, and by the cavitation phenomenon, the liquid boils with the nuclei of fine bubbles of 100 microns or less existing in the liquid as nuclei, to generate a large number of small bubbles. Fine bubbles generated by vaporization reduce the surface tension of water, thereby improving permeability and lubricity. Alternatively, air or other gas is injected into the fluid in advance (a gas injection unit is provided in the middle of the pipe 12 in FIG. 1), and the collision of the fluid with the plurality of pillars 540p and 550p causes the dissolved gas to be released, so that a large number of fine bubbles may be generated.

The fluid that has passed through the plurality of narrow intersecting flow paths 540r on each lateral face of the quadrangular prism 542 of the outer internal structure 540 flows toward the end of the outer internal structure 540. In addition, the fluid that has passed through the plurality of narrow intersecting flow paths 550r in a cylindrical shape of the inner internal structure 550 flows to the end of the inner internal structure 550. Then, the two flows merge and are guided toward the center of the tubular body 110 by the guiding portion 552 provided at the downstream end of the inner internal structure 550, and flow out to the space where the tapered portion 136 is located downstream. Thereafter, the fluid exits through the outlet 112 and is discharged toward the machining location G or the like through the nozzles 5-1 to 5-6 in FIG. 1.

On the other hand, although the truncated quadrangular pyramid 543 is provided at the upstream portion of the outer internal structure 540 for efficiently dispersing the inflowing fluid to each lateral face, such a feature is not an essential construction. Further, several blades are provided upstream of the inner internal structure 550 to generate, for example, a swirling flow in a counterclockwise direction, and the blades are effective in generating a swirling flow but are not necessarily required. Furthermore, although the guiding portion 552 in a dome shape is provided downstream of the inner internal structure 550, the guiding portion 552 may have a conical shape or may just be removed. The guiding portion 552 is not an essential component.

### Sixth Embodiment

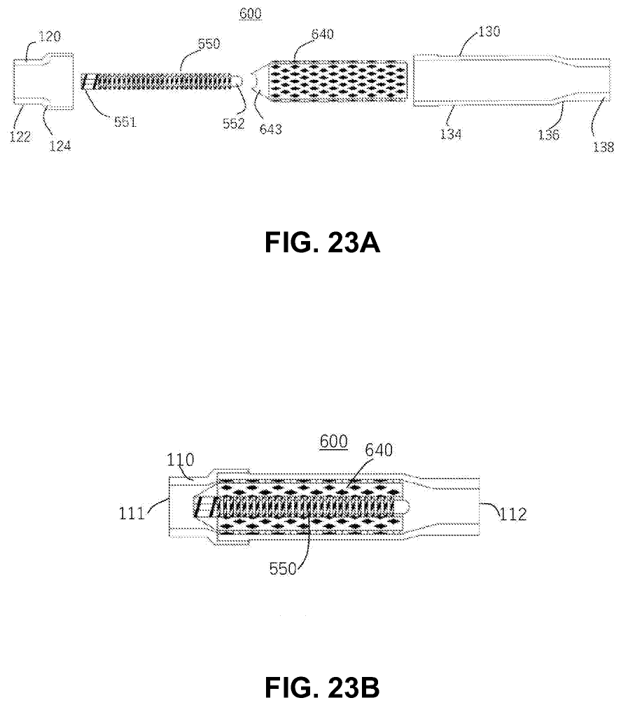

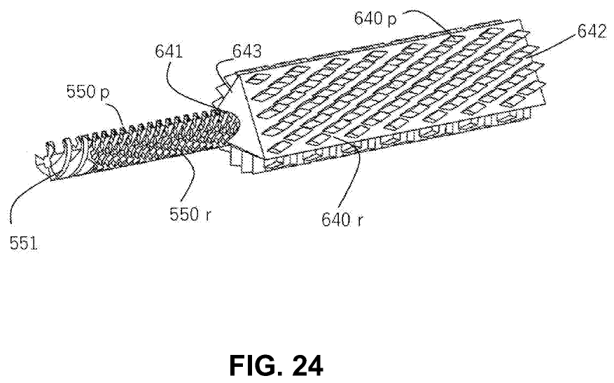

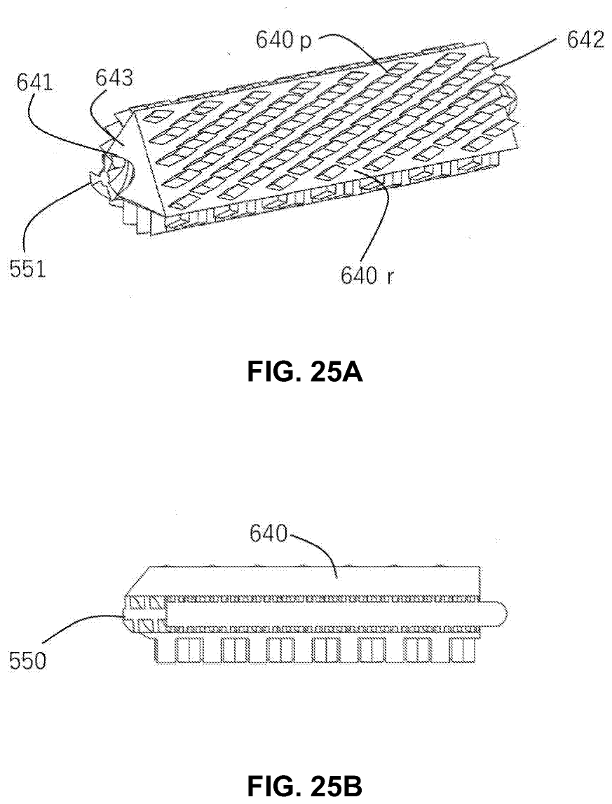

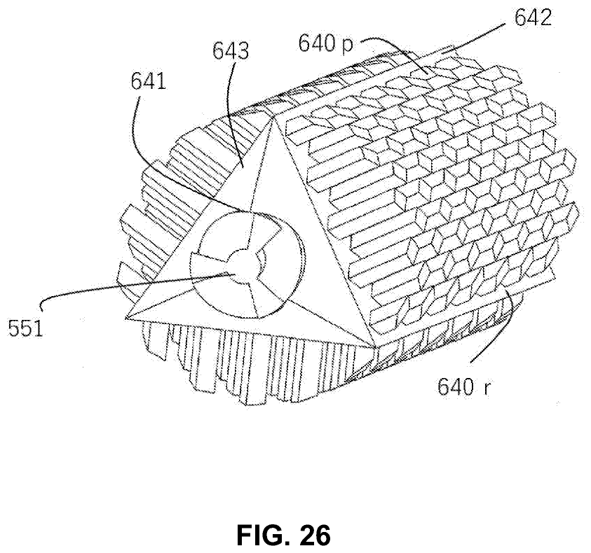

Next, a fluid supply pipe 600 according to a sixth embodiment of the present invention will be described with reference to FIGS. 23A to 26. In the present embodiment, the description of the same features as those of the fourth embodiment or the fifth embodiment will not be repeated, and the difference features will be described in greater detail. The same reference numerals and symbols will be used for the same components as those of the fourth embodiment or the fifth embodiment. FIG. 23A is an exploded side view of the fluid supply pipe 600 according to the sixth embodiment, and FIG. 23B is a side see-through view of the fluid supply pipe 600. As shown in FIGS. 23A and 23B, the fluid supply pipe 600 comprises a tubular body 110, a first internal structure (outer internal structure) 640, and a second internal structure (inner internal structure) 550. The second internal structure (inner internal structure) 550 has exactly the same construction as that of the fifth embodiment. The internal structure 640 comprises a triangular prism 642 (the bottom surface is of an equilateral triangle) the same as in the fourth embodiment, but has a cylindrical cavity 641 formed therethrough, and the second internal structure 550 is housed in this cavity 641. A truncated triangular pyramid 643 with the leading end cut off of the triangular pyramid is provided upstream of the outer internal structure 640. More specifically speaking, as shown in FIG. 23A, the cutout has a circular cross-section. FIG. 24 is a three-dimensional perspective view showing a state where the second internal structure (inner internal structure) 550 is being received in the outer internal structure 640. FIG. 25A is a three-dimensional perspective view showing a state in which the second internal structure (inner internal structure) 550 is housed in the outer internal structure 640, and FIG. 25B is a partial cross-sectional view thereof. FIG. 26 is a three-dimensional perspective view from a different direction.

As in the fourth and fifth embodiments, the first and second internal structures 640 and 550 are formed by, for example, a method of performing metalworking on a columnar member made of a metal such as steel or aluminum, or a method of molding a resin such as plastic, and the like. Alternatively, it may also be possible to use a 3D printer with a metal or resin. When a metallic cylindrical shaft is machined, a cutting, turning, or grinding process is performed alone or in combination. For example, it is possible to perform cutting by an end mill. The manufacturing process comprises a step of preparing an inner internal shaft having an outer shape of a cylinder, a step of forming one or more blades 551 in a spiral shape (e.g., counterclockwise direction) at an upstream end of the inner internal shaft, a step of forming a plurality of pillars 550p with the bottom surface thereof being the same height as the bottom surface of intersecting flow paths and the top surface thereof being the same as the height of lateral face of the cylinder by forming the intersecting flow paths 550r of a predetermined depth from the lateral face of the cylinder on the outer surface downstream of the inner internal shaft, and a step of forming a guiding portion 552 in a dome shape or conical shape at the downstream end of the inner internal shaft, and the inner internal structure 550 is formed through these steps. In a more specific example, the plurality of pillars 550p are formed by forming a plurality of annular and spiral (e.g., counterclockwise direction, respectively) intersecting flow paths 550r as the intersecting flow paths. And the outer internal structure 640 is formed by a step of preparing a cylindrical outer internal shaft, a step of making the upstream side of the outer internal shaft into a truncated triangular pyramid 643, a step of forming a hollow cylindrical cavity 641 (having a circular entrance) through the outer internal shaft in which the inner internal shaft is disposed, and a step of forming a plurality of pillars 640p with the bottom surface thereof being a lateral face of the prism and the top surface thereof being the lateral face of the cylinder by forming intersecting flow paths 640r with the bottom surface being a lateral face of the triangular prism and the top surface being the outer diameter of the cylinder, with respect to the cylindrical outer internal shaft. A process of disposing the inner internal structure 550 having the plurality of pillars 550p and the intersecting flow paths 550r or the like in the hollow cavity 641 of the outer internal structure 640 having the plurality of pillars 640p and the intersecting flow paths 640r achieves housing and assembly thereof.

As shown in FIGS. 24 to 25B, a cylindrical shaft is machined to form the truncated triangular pyramid 643 at the leading end, to form the triangular prism 642 (the bottom surface is of an equilateral triangle) on the downstream side of the outer internal structure 640, and to form the plurality of pillars 640p on three lateral faces of the triangular prism 642. The plurality of pillars 640p are arranged in a mesh pattern, the bottom surface thereof is the same surface as the lateral face of the triangular prism 642, the top surface thereof is the outer surface of the original cylindrical internal shaft, and the plurality of pillars 640p are rounded with a height in the shape of an arc as a whole. The arrangement of the plurality of pillars 640p is the same as that described in the fourth embodiment (see FIG. 18A). The hollow cylindrical cavity 641 is formed through the outer internal structure 640 from the circular leading end of the truncated triangular pyramid 643 to the inside thereof. On the other hand, the inner internal structure 550 is the same as that described in the fifth embodiment. As shown in FIGS. 25A and 25B, when the inner internal structure 550 is inserted into the outer internal structure 640 and then further inserted into and fixed to the tubular body 110 as shown in FIG. 23B, the truncated triangular pyramid 643 diffuses and guides part of the inflowing fluid from the center of the circle of the tubular body 110 having a circular cross-section to each lateral face of the triangular prism 642 of the outer internal structure 640, and a portion of this fluid will pass through the flow paths 640r. In addition, the remainder of the inflowing fluid flows from the circular inlet of the truncated triangular pyramid 643 into the cavity 641, passes through the plurality of blades 551 that create a counterclockwise spiral flow, and through the flow paths 550r of the inner internal structure 550. That is, in the sixth embodiment, the fluid flowing in from the inlet 111 of the tubular body 110 is divided into two flows, one of which passes through the intersecting flow paths 550r formed on the inner internal structure 550 and the other of which passes through the flow paths 640r formed on the outer internal structure 640, and then the divided flows merge at the respective downstream ends to head toward the outlet 112.

Hereinafter, the flow of a fluid while passing through the fluid supply pipe 600 will be described. The fluid flowing in through the inlet 111 passes through the space in the tapered portion 124 of the inlet-side member 120, strikes the truncated triangular pyramid 643 of the internal structure 640, where part of the fluid is guided outward from the center of the fluid supply pipe 600 (i.e., in the radial direction and in the direction toward the bottom surface of the truncated triangular pyramid 643), and flows into the intersecting flow paths 640r formed inside by the internal structure 640 and the tubular body 110. The remainder of the fluid flows from the circular opening of the truncated triangular pyramid 643 into the intersecting flow paths 550r formed inside by the internal structure 550 and the cylindrical cavity 641 via the blades 551.

By the fluid passing through the plurality of narrow flow paths 640r formed by the plurality of pillars 640p of the outer internal structure 640 and passing through the plurality of narrow flow paths 550r formed by the plurality of pillars 550p of the inner internal structure 550, a large number of small vortices are generated. Furthermore, the fluid collides with and sheared by the plurality of pillars 640p, and repeats collision, mixing, and dispersion in the plurality of intersecting flow paths 640r in the outer internal structure 640. In the inner internal structure 550, the fluid collides with and sheared by the plurality of pillars 550p, and repeats collision, mixing, and dispersion in the plurality of intersecting flow paths 550r. In addition, because of the multi-stage arrangement in a mesh pattern of the plurality of pillars 640p, a flip-flop phenomenon in which a fluid flows alternately to switch to the left and right occurs in the intersecting flow paths 640r. Such a phenomenon induces mixing and diffusion of the fluid. The structure of the pillars 640p and 550p as described above is also useful when mixing two or more fluids having different properties.

The internal structures 640 and 550 have a construction to allow the fluid to flow from the upstream side (the truncated triangular pyramid 643 having the circular inlet) having a larger cross-sectional area to the downstream side (the intersecting flow paths 640r formed between the plurality of pillars 640p and the intersecting flow paths 550r formed between the plurality of pillars 550p) having a smaller cross-sectional area. As described in the first embodiment, the static pressure is reduced in accordance with Bernoulli's equation, and by the cavitation phenomenon, the liquid boils with the nuclei of fine bubbles of 100 microns or less existing in the liquid as nuclei, to generate a large number of small bubbles. Fine bubbles generated by vaporization reduce the surface tension of water, thereby improving permeability and lubricity thereof. Alternatively, air or other gas is injected into the fluid in advance (a gas injection unit is provided in the middle of the pipe 12 in FIG. 1), and the collision of the fluid with the plurality of pillars 640p and 550p causes the dissolved gas to be released, so that a large number of fine bubbles may be generated.

The fluid that has passed through the plurality of narrow intersecting flow paths 640r on each lateral face of the triangular prism 642 of the outer internal structure 640 flows toward the downstream end of the outer internal structure 640. Moreover, the fluid that has passed through the plurality of narrow intersecting flow paths 550r in a cylindrical shape of the inner internal shaft 550 flows to the downstream end of the inner internal structure 550. Then, the two flows merge and are guided toward the center of the tubular body 110 by the guiding portion 552 provided at the downstream end of the inner internal structure 550, and flow out to the space where the tapered portion 136 is provided downstream. Thereafter, the fluid exits through the outlet 112 and is discharged toward the machining location G or the like through the nozzles 5-1 to 5-6 in FIG. 1.

Further, though the truncated triangular pyramid 643 is provided at the upstream portion of the outer internal structure 640 for efficiently dispersing the inflowing fluid to each lateral face, such a feature is not an essential configuration. In addition, several blades 551 are provided upstream of the internal structure 550 to generate, for example, a swirling flow in a counterclockwise direction, and the blades are effective in generating a swirling flow but are not necessarily required. Moreover, although the guiding portion 552 in a dome shape is provided downstream of the inner internal structure 550, the guiding portion 552 may have a conical shape or may just be removed. The guiding portion 552 is not an essential component.

### Seventh Embodiment

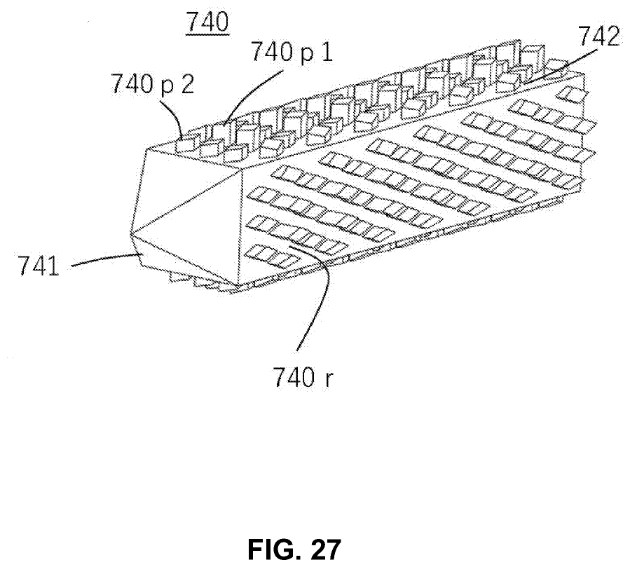

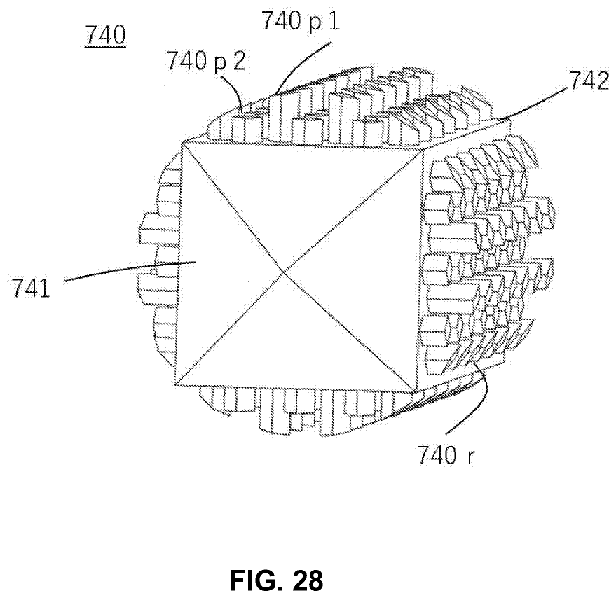

Next, an internal structure 740 according to a seventh embodiment of the present invention will be described with reference to FIG. 27 and FIG. 28. This embodiment provides an internal structure of a fluid supply pipe capable of appropriately shearing, stirring, diffusing, and mixing by taking measures against a pressure loss even when the viscosity of a fluid flowing therein is high (including a case where the viscosity of at least one fluid is high when a plurality of fluids are mixed, for example, when a highly viscous oil such as an emulsion fuel is mixed with water, etc.). As shown in FIG. 27, the internal structure 740 is substantially the same as the internal structure 140 (see FIGS. 3 and 4) described in the first embodiment, and the internal structure 740 is formed by, for example, a method of performing metalworking on a cylindrical member made of a metal such as steel or aluminum, a method of molding a resin such as plastic, and the like. Alternatively, it may also be possible to use a 3D printer with a metal or resin. When a metallic cylindrical shaft is machined, a cutting, turning, or grinding process is performed alone or in combination. For example, it is possible to perform cutting by an end mill. The manufacturing process comprises a step of preparing a cylindrical internal shaft, a step of forming one end of the cylindrical internal shaft into a quadrangular pyramid 741, and a step of forming a plurality of pillars 740p1 and 740p2 with the bottom surface thereof being a lateral face of a prism and the top surface thereof being the lateral face of the cylinder by forming intersecting flow paths 740r with the bottom surface being a lateral face of a quadrangular prism 742 and the top surface being the outer diameter of the cylinder (In this case, the pillars 740p1 and the pillars 740p2 have different heights from each other). It is preferred that the radius of the original cylindrical member is the same as or slightly smaller than that of the inner wall of the tubular body 110, and that the cylindrical member is sized to be housed inside the tubular body leaving no gap therebetween.

FIG. 28 is a three-dimensional perspective view of the internal structure 740 of FIG. 27 viewed from another direction. As described above, a cylindrical shaft is machined to form the quadrangular pyramid 741 at the leading end, to form the quadrangular prism 742 in the remaining portion thereof, and to form the plurality of pillars 740p1 and 740p2 on the four lateral faces of the quadrangular prism 742. The plurality of pillars 740p1 and 740p2 are arranged in a mesh pattern, the bottom surface thereof is the same surface as the outer surface of the quadrangular prism 742, the top surface of the pillars 740p1 is the outer surface of the original cylindrical internal shaft, and the pillars 740p1 and 740p2 are rounded with a height in the shape of an arc as a whole. Further, the pillars 740p2 have a constant low height. In the present embodiment, those arranged in a group of three to form each row from upstream to downstream are the pillars 740p2 having a constant low height, and thus there are 21 pillars 740p2 having a constant low height out of a total of 49 pillars (total number of the pillars 740p1 and the pillars 740p2) on one lateral face (see FIG. 5A). The fluid that has reached each lateral face by way of the quadrangular pyramid 741 flows through the intersecting flow paths 740r formed between the plurality of pillars 740p1 and pillars 740p2, but since height of the cylindrical inner wall surface of the tubular body 110 and that of the plurality of pillars 740p1 are substantially the same (no gap therebetween), the fluid will flow between the plurality of pillars 740p (i.e., there is substantially no flow over the top surfaces of the plurality of pillars 740p). In contrast, since the height of the plurality of pillars 740p2 is constant and a gap (larger in the central area and smaller in the lateral direction) is created between the cylindrical inner wall surface of the tubular body 110 and the pillars 740p2, the fluid can pass through this gap. With the presence of an auxiliary flow path formed by the gap between the pillars 740p2 having a certain height and the inner wall surface of the tubular body 110 in addition to the intersecting flow paths 740r, the present embodiment improves the occurrence of pressure loss caused by the sole flow on the flow paths 740r between the plurality of pillars. Other features and operations of the present embodiment are the same as those of the first embodiment, and thus the description thereof will not be repeated.

The arrangement of the pillars 740p2 may be selected and changed appropriately according to pressure loss situations, and in other embodiments, those arranged in a group of four to form each row (see FIG. 5A) from upstream to downstream on each lateral face of the quadrangular prism 742 may serve as the pillars 740 having a constant height. In addition, the low pillars 740p2 may also be repeatedly provided once every other row or once in a plurality of rows from the upstream to the downstream. Furthermore, instead of the two levels of high and low pillars 740p1 and 740p2, three or multiple levels of pillars may also be provided. Moreover, the low pillars 740p2 may also be provided diagonally along the flow. In any case, with the viscosity of a fluid and the capability of shearing, stirring, diffusing, and mixing at the pillars, the pressure loss in the fluid supply pipe can be improved by appropriately changing the way the high pillars 740p1 and the low pillars 740p2 (and further, pillars having multiple levels of height) are arranged.

### Eighth Embodiment

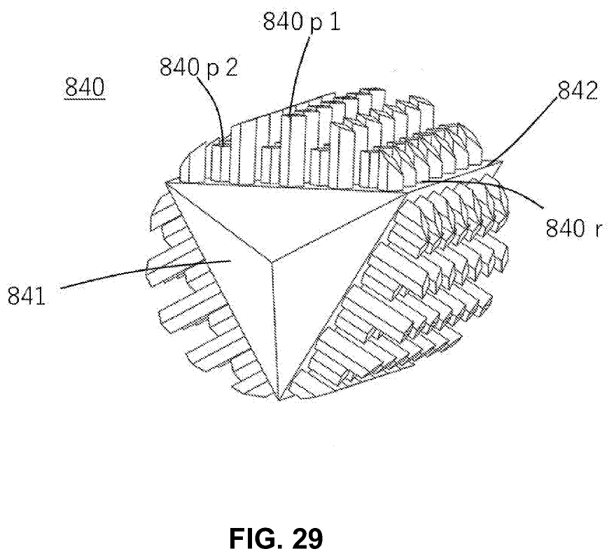

Next, an internal structure 840 according to an eighth embodiment of the present invention will be described with reference to FIG. 29. As in the seventh embodiment, this embodiment provides an internal structure of a fluid supply pipe capable of appropriately shearing, stirring, diffusing, and mixing by taking measures against a pressure loss even when the viscosity of a fluid flowing therein is high (including a case where the viscosity of at least one fluid is high when a plurality of fluids are mixed, for example, when a highly viscous oil such as an emulsion fuel is mixed with water, etc.). In this embodiment, when the viscosity of the fluid flowing inside is high (when a plurality of fluids are mixed, the viscosity of at least one fluid is high, for example, when The present invention provides an internal structure of a fluid supply pipe capable of taking measures against pressure loss and appropriately performing shearing, stirring, diffusion, and mixing even when high oil and water are mixed. As shown in FIG. 29, the internal structure 840 is substantially the same as the internal structure 240 (see FIG. 7) described in the second embodiment, and the internal structure 840 is formed by, for example, a method of performing metalworking on a cylindrical member made of a metal such as steel or aluminum, a method of molding a resin such as plastic, and the like. Alternatively, it may also be possible to use a 3D printer with a metal or resin. When a metallic cylindrical shaft is machined, a cutting, turning, or grinding process is performed alone or in combination. For example, it is possible to perform cutting by an end mill. The manufacturing process comprises a step of preparing a cylindrical internal shaft, a step of forming one end of the cylindrical internal shaft into a triangular pyramid 841, and a step of forming a plurality of pillars 840p1 and 840p2 with the bottom surface thereof being a lateral face of a prism and the top surface thereof being the lateral face of the cylinder by forming intersecting flow paths 840r with the bottom surface being a lateral face of the triangular prism 842 and the top surface being the outer diameter of the cylinder. (In this case, the pillars 840p1 and the pillars 840p2 have different heights from each other). It is preferred that the radius of the original cylindrical member is the same as or slightly smaller than that of the inner wall of the tubular body 110, and that the cylindrical member is sized to be housed inside the tubular body leaving no gap therebetween. As described above, a cylindrical shaft is machined to form the triangular pyramid 841 at the leading end, to form the triangular prism 842 in the remaining portion thereof, and to form the plurality of pillars 840p1 and 840p2 on three lateral faces of the triangular prism 842. The plurality of pillars 840p1 and 840p2 are arranged in a mesh pattern, the bottom surface thereof is the same surface as the outer surface of the triangular prism 842, the top surface of the pillars 840p1 is the outer surface of the original cylindrical internal shaft, and the pillars 840p1 and 840p2 are rounded with a height in the shape of an arc as a whole. The pillars 840p2 have a constant height. In the present embodiment, those pillars 840p2 having a constant low height arranged in a group of four to form each row from the upstream side to the downstream side serve as the pillars 840p of a constant height, and thus there are 28 pillars 840p2 having a constant low height out of a total of 63 pillars (total number of the pillars 840p1 and the pillars 840p2) on one side (see FIG. 8A). The fluid that has reached each lateral face by way of the triangular pyramid 841 flows through the intersecting flow paths 840r formed between the plurality of pillars 840p1 and 840p2, but since the height of the cylindrical inner wall surface of the tubular body 110 and that of the plurality of pillars 840p1 are substantially the same (is no gap therebetween), the fluid will flow between the plurality of pillars 840p (i.e., (i.e., there is substantially no flow over the top surfaces of the plurality of pillars 840p1). In contrast, since the height of the plurality of pillars 840p2 is low, a gap (larger in the central area and it gets smaller as it goes sideways) is created between the cylindrical inner wall surface of the tubular body 110 and the top surface of the pillars 840p2, and thus the fluid can pass through this gap. With the presence of an auxiliary flow path formed by the gap between the pillars 840p2 having a constant low height and the inner wall surface of the tubular body 110, the present embodiment improves the occurrence of pressure loss caused by the sole flow on the flow paths 740r between the plurality of pillars. Other features and operations of the present embodiment are the same as those of the second embodiment, and thus the description thereof will not be repeated.

The arrangement of the pillars 840p2 may be selected and changed appropriately according to pressure loss situations, and in other embodiments, those arranged in a group of five to form each row from upstream to downstream on each lateral face of the triangular prism 842 may also serve as the pillars 840p2 having a constant height, and the pillars 840p2 may be repeatedly provided once in a plurality of rows instead of every other row. Further, instead of two levels of the high and low pillars 840p1 and 840p2, three or multiple levels of pillars may also be provided. Moreover, the low pillars 840p2 may also be provided diagonally along the flow. In any case, with the viscosity of a fluid and the capability of shearing, stirring, diffusing, and mixing at the pillars, the pressure loss in the fluid supply pipe can be improved by appropriately changing the way the high pillars 840p1 and the low pillars 840p2 (and further, pillars having multiple levels of height) are arranged.

### Ninth Embodiment

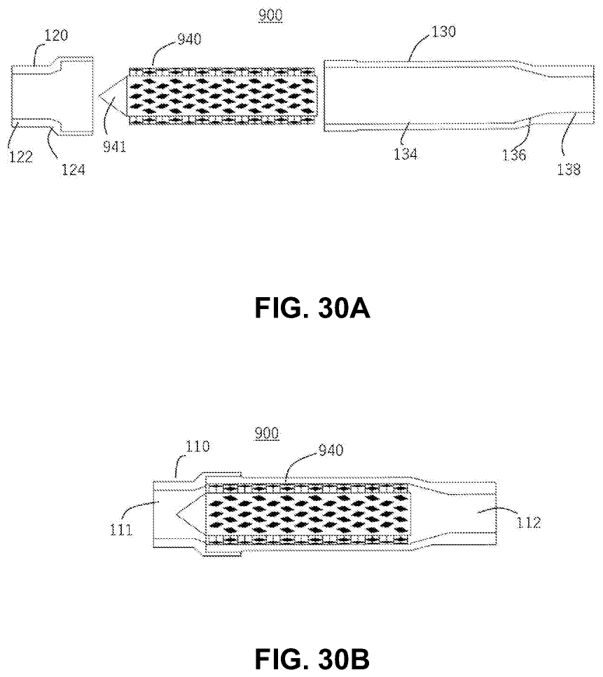

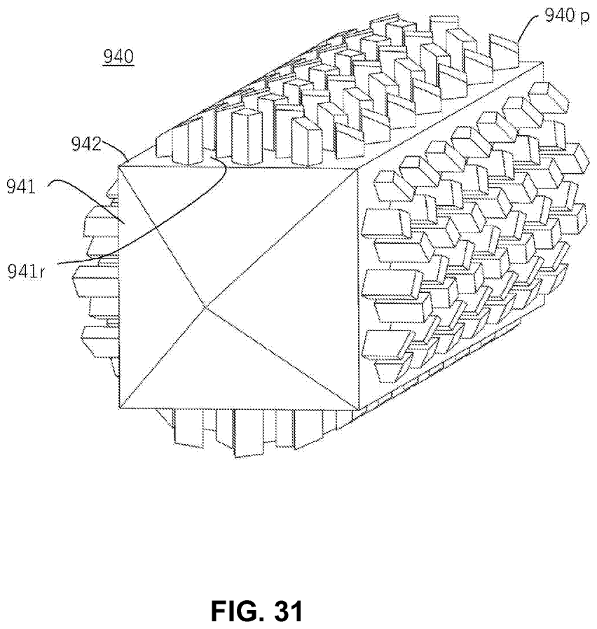

Next, a fluid supply pipe 900 according to a ninth embodiment of the present invention will be described with reference to FIGS. 30A to 32B. The description of the same features as those of the first embodiment will not be repeated, and the different features will be described in greater detail. FIG. 30A is an exploded side view of the fluid supply pipe 900 according to the ninth embodiment of the present invention, and FIG. 30B is a side see-through view of the fluid supply pipe 900. FIG. 31 is a three-dimensional perspective view of an internal structure 940 of the fluid supply pipe 900.

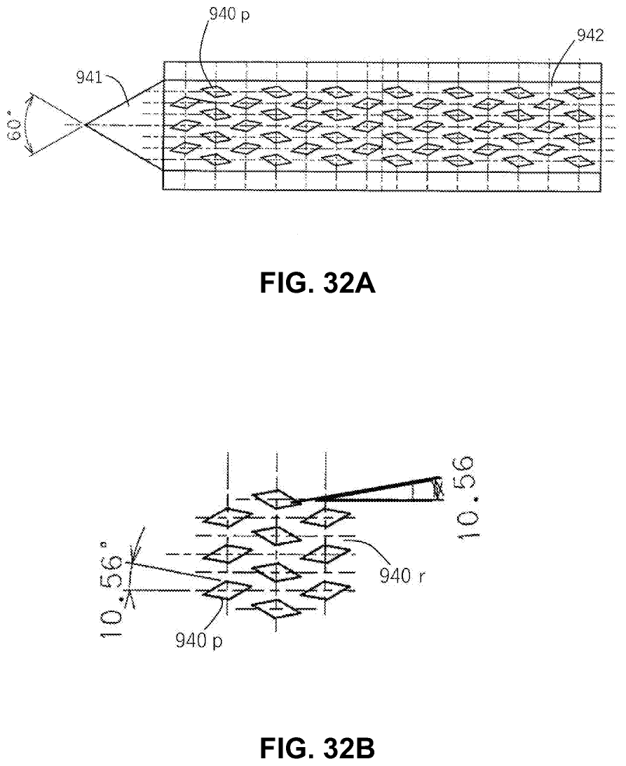

FIG. 32A illustrates one lateral face of the internal structure 940 on a plane and shows a quadrangular pyramid 941 and an arrangement of pillars 940p, and the apex angle of the quadrangular pyramid 941 on the upstream side is, for example, 60 degrees. Of course, this angle may be changed as appropriate. And, rhombic (the shape of the bottom) pillars 940p with a vertex angle of 41.11° are formed in a mesh pattern on the four lateral faces of the quadrangular prism 942 on the downstream side as in the first embodiment. Note that the vertex angle may also be appropriately changed. However, unlike the first embodiment, the plurality of pillars 940p arranged in a mesh pattern are slightly tilted. That is, the rhombus of the bottom surface of the three pillars 940p on the most upstream side is tilted slightly (10.56°) to the left about the center thereof with respect to the longitudinal direction of the shaft of the internal structure 940 as shown in FIG. 32B. The rhombus of the bottom surface of the four pillars 940p in the next row is tilted slightly (10.56°) to the right about the center thereof with respect to the longitudinal direction of the shaft of the internal structure 940. Thence, each row is likewise, alternately tilted to the left and right direction. Of course, this tilt angle (10.56°) is not limited thereto. Therefore, in the present embodiment, although the intersecting angle of the intersecting flow paths 940r formed between the plurality of pillars 940p is 41.11° as in the first embodiment, since the pillars 940p are slightly tilted in different directions to the left and right for each row and accordingly part of the pillars 940p protrudes to the flow paths, the frequency of collision of the fluid with the pillars 940p increases over the first embodiment and turbulent flows are generated including a number of small vortices, thereby increasing the effect of shearing, stirring, diffusing, and mixing the fluid. Further, such a feature is also effective in generating fine bubbles. In addition, the plurality of pillars 940p having a bottom surface of a rhombic shape formed on one lateral face are arranged in 14 rows of a sequence of three pillars, four pillars, three pillars, . . . , four pillars from upstream to downstream, and thus there are 49 pillars on one lateral face, resulting in a total of 196 pillars on the four lateral faces, as in the first embodiment. Of course, this number may be changed as appropriate. The shape of the plurality of pillars 940p may be such that the bottom surface of the pillars may not be of a rhombic shape (e.g., a triangle, a polygon, or the like), and the arrangement thereof may be appropriately changed (angle, interval, etc.) from FIGS. 32A and 32B.

As in other embodiments, the internal structure 940 is formed by, for example, a method of performing metalworking on a cylindrical member made of a metal such as steel or aluminum, a method of molding a resin such as plastic, and the like. Alternatively, it may also be possible to use a three-dimensional (3D) printer with a metal or resin. When a metallic cylindrical shaft is machined, a cutting, turning, or grinding process is performed alone or in combination. For example, it is possible to perform cutting by an end mill. The manufacturing process comprises a step of preparing a cylindrical internal shaft, a step of forming one end of the cylindrical internal shaft into a pyramid (a quadrangular pyramid 941 in the case of the ninth embodiment), and a step of forming a plurality of pillars 940p with the bottom surface thereof being a lateral face of a prism and the top surface thereof being the lateral face of the cylinder by forming intersecting flow paths 940r with the bottom surface being a lateral face of the prism (a quadrangular prism 942 whose bottom surface is a square in the case of the ninth embodiment) and the top surface being the outer diameter of the cylinder. In this case, it is necessary to change the tilt angle of the pillars 940p to the right and left alternately for each row. A cylindrical shaft is machined to form a quadrangular pyramid 941 at the leading end, to form a quadrangular prism 942 in the remaining portion thereof, and to form a plurality of pillars 940p on the four lateral faces of the quadrangular prism 942. The plurality of pillars 940p are arranged in a mesh pattern, the bottom surface thereof is the same surface as the outer surface (lateral face) of the quadrangular prism 942, the top surface thereof is the outer surface of the original cylindrical internal shaft, and plurality of pillars 940p are rounded with a height in the shape of an arc as a whole. Other features and operations of the present embodiment are the same as those of the first embodiment, and the description thereof will not be repeated. Also, the arrangement of the pillars 340p, 350p, 540p, 740p1, 740p2 described in the third, fifth, and seventh embodiments may be slightly tilted in different directions to the left and right for each row as in FIGS. 32A and 32B. In such a case, since part of the pillars protrudes to the flow paths, the frequency of collision of the fluid with the pillars increases and turbulent flows are generated including a number of small vortices, thereby increasing the effect of shearing, stirring, diffusing, and mixing the fluid. Further, such a feature is also effective in generating fine bubbles.

### Tenth Embodiment

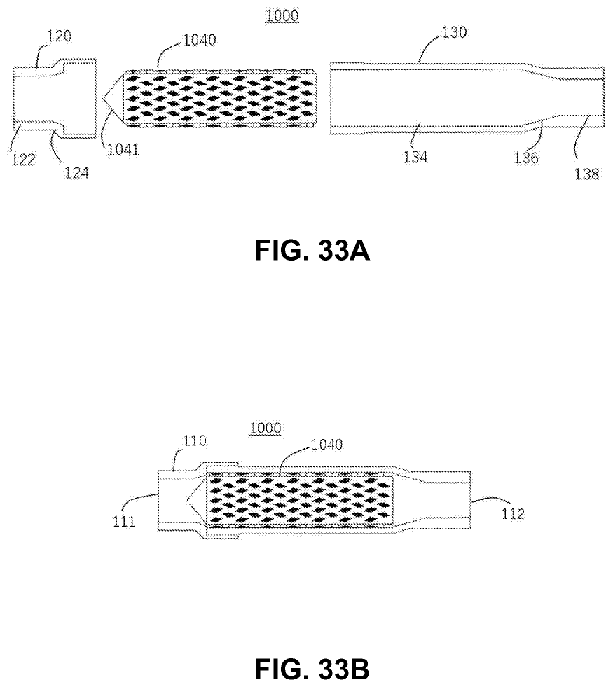

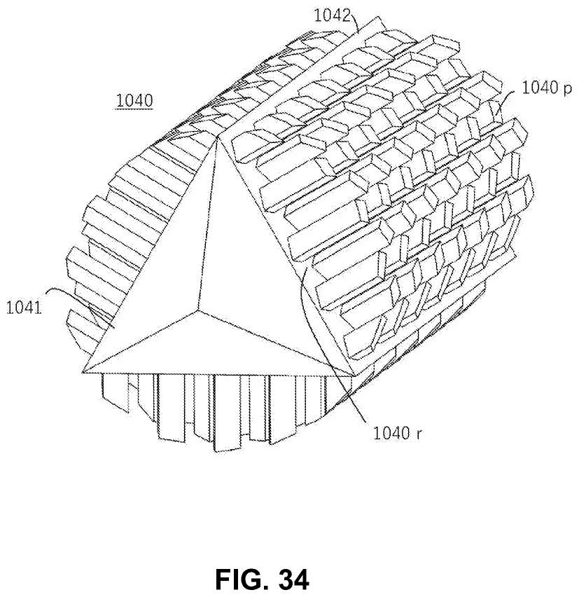

Next, a fluid supply pipe 1000 according to a tenth embodiment of the present invention will be described with reference to FIGS. 33A to 35B. The description of the same features as those of the second embodiment will not be repeated, and the different features will be described in greater detail. FIG. 33A is an exploded side view of the fluid supply pipe 1000 according to the tenth embodiment of the present invention, and FIG. 33B is a side see-through view of the fluid supply pipe 1000. FIG. 34 is a three-dimensional perspective view of an internal structure 1040 of the fluid supply pipe 1000.

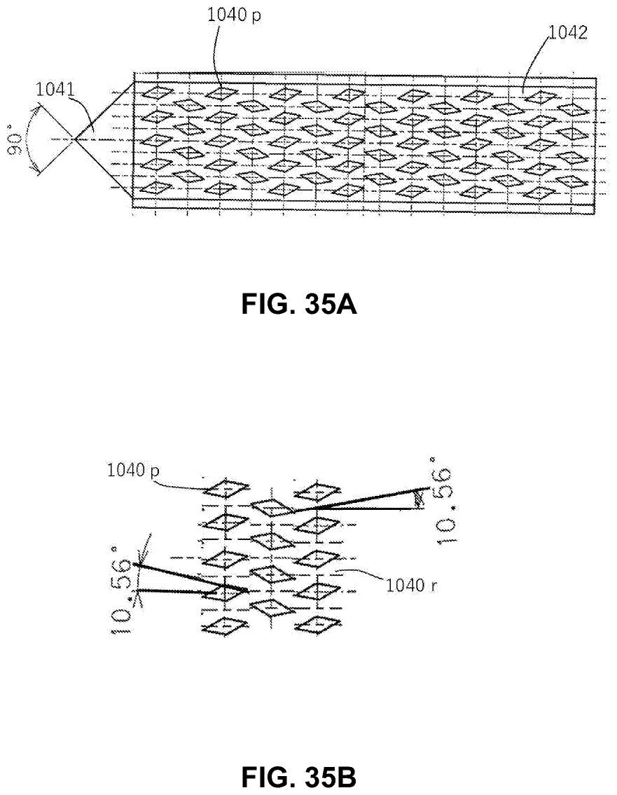

FIG. 35A shows a triangular pyramid 1041 and an arrangement of a plurality of pillars 1040p by illustrating one lateral face of the internal structure 1040 on a plane, and the apex angle of the triangular pyramid 1041 on the upstream side is, for example, 90 degrees. Of course, this angle may be changed as appropriate. As in the second embodiment, rhombic (the shape of the bottom) pillars 1040p with a vertex angle of 41.11° are formed in a mesh pattern on the three lateral faces of the triangular prism 1042 on the downstream side. Also, the vertex angle may also be appropriately changed. However, unlike the second embodiment, the plurality of pillars 1040p arranged in a mesh pattern are slightly tilted. That is, the rhombus of the bottom surface of the five pillars 1040 on the most upstream side is tilted slightly (10.56°) to the left about the center thereof with respect to the longitudinal direction of the shaft of the internal structure 1040 as shown in FIG. 35B. And, the rhombus of the bottom surface of the four pillars 1040p in the next row is tilted slightly (10.56°) to the right about the center thereof with respect to the longitudinal direction of the shaft of the internal structure 1040. Thence, each row is, likewise, alternately tilted to the left and right direction. Of course, this tilt angle (10.56°) is not limited thereto.

Therefore, in the present embodiment, although the intersecting angle of the intersecting flow paths 1040r formed between the plurality of pillars 1040p is 41.11° as in the second embodiment, since the pillars 1040p are slightly tilted in different directions to the left and right for each row and accordingly part of the pillars 1040p protrudes to the flow paths, the frequency of collision of the fluid with the pillars 1040p increases over the second embodiment and turbulent flows are generated including a number of small vortices, thereby increasing the effect of shearing, stirring, diffusing, and mixing the fluid. Further, such a feature is also effective in generating fine bubbles. On the other hand, the plurality of pillars 1040p having a bottom surface of a rhombic shape formed on one lateral face are arranged 14 rows of a sequence of five pillars, four pillars, five pillars, . . . , four pillars from upstream to downstream, and thus there are 63 pillars on one lateral face, resulting in a total of 189 pillars on the three lateral faces, as in the second embodiment. Of course, this number may be changed as appropriate. The shape of the plurality of pillars 1040p may be such that the bottom surface of the pillars may not be of a rhombic shape (e.g., a triangle, a polygon, or the like), and the arrangement thereof may be appropriately changed (angle, interval, etc.) from FIGS. 35A and 35B.

As in other embodiments, the internal structure 1040 is formed by, for example, a method of performing metalworking on a cylindrical member made of a metal such as steel or aluminum, a method of molding a resin such as plastic, and the like. Alternatively, it may also be possible to use a three-dimensional (3D) printer with a metal or resin. When a metallic cylindrical shaft is machined, a cutting, turning, or grinding process is performed alone or in combination. For example, it is possible to perform cutting by an end mill. The manufacturing process comprises a step of preparing a cylindrical internal shaft, a step of forming one end of the cylindrical internal shaft into a pyramid (a triangular pyramid 1041 in the tenth embodiment), and a step of forming a plurality of pillars 1040p with the bottom surface thereof being a lateral face of a prism and the top surface thereof being the lateral face of the cylinder by forming intersecting flow paths 1040r with the bottom surface being a lateral face of the prism (a triangular prism 1042 whose bottom surface is a triangle in the case of the tenth embodiment) and the top surface being the outer diameter of the cylinder. In this case, it is necessary to change the tilt angle of the pillars 1040p to the right and left alternately for each row. A cylindrical shaft is machined to form the triangular pyramid 1041 at the leading end, to form the triangular prism 1042 in the remaining portion thereof, and to form the plurality of pillars 1040p on three lateral faces of the triangular prism 1042. The plurality of pillars 1040p are arranged in a mesh pattern, the bottom surface thereof is the same surface as the outer surface (lateral face) of the triangular prism 1042, the top surface thereof is the outer surface of the original cylindrical internal shaft, and the plurality of pillars 1040p are rounded with a height in the shape of an arc as a whole. Other features and operations of the present embodiment are the same as those of the second embodiment, and the description thereof will not be repeated. Also, the arrangement of the pillars 440p, 450p, 640p, 840p1, and 840p2 described in the fourth, sixth, and eighth embodiments may be slightly tilted in different directions to the left and right for each row as in FIGS. 35A and 35B. In such a case, since part of the pillars protrudes to the flow paths, the frequency of collision of the fluid with the pillars increases and turbulent flows are generated including a number of small vortices, thereby increasing the effect of shearing, stirring, diffusing, and mixing the fluid. Further, such a feature is also effective in generating fine bubbles.

(Modifications of Pillars)

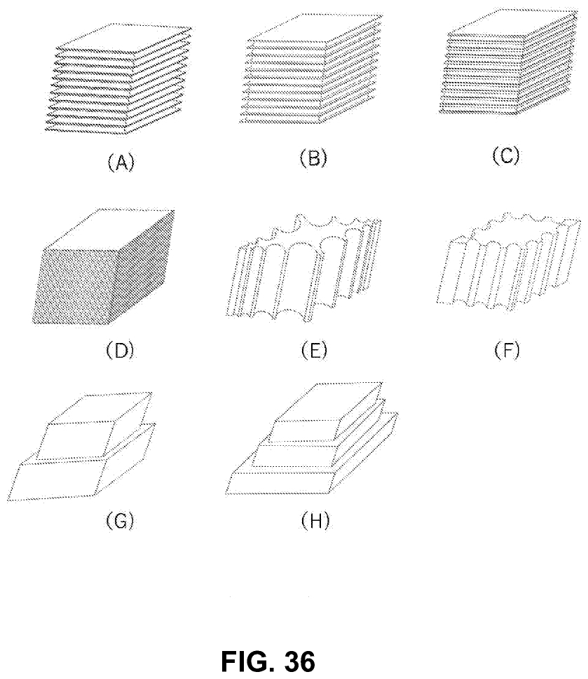

Next, modifications of the plurality of pillars 140p to 640p, 350p to 550p, 740p1, 740p2, 840p1, 840p2, 940p, and 1040p in each of the embodiments described above will be described with reference to FIG. 36. The lateral faces of each pillar have been flat in the embodiments described above, but the lateral faces are made uneven to vary the flow of a fluid in the present modification. That is, they are for inducing a more complicated flow. A turbulent flow including a small vortex may be easily generated by providing a fine flow path, or a cavitation phenomenon may be more easily induced by forming a narrower flow path. Specifically, parallel uneven features are provided in the horizontal direction as shown in FIGS. 36A to 36C. Alternatively, parallel uneven features are provided in the vertical direction as shown in FIG. 36 (D). As shown in FIGS. 36 (E) and (F), uneven features having a plurality of curved surfaces (the cross section of which is of a geometric pattern) are vertically formed. Furthermore, a plurality of steps are provided as shown in FIGS. 36 (G) and (H). The shapes of these uneven features may be formed of a metal or a resin using a 3D printer. When a metallic shaft is machined, a cutting, turning, or grinding process is performed alone or in combination. For example, it is possible to perform cutting by an end mill. Alternatively, the lateral faces of a pillar may be provided with a matte pattern or the like, or a texture processing may be performed thereon, though not shown in FIG. 36. These may be implemented by a method such as an etching treatment or sandblasting.

### Eleventh Embodiment

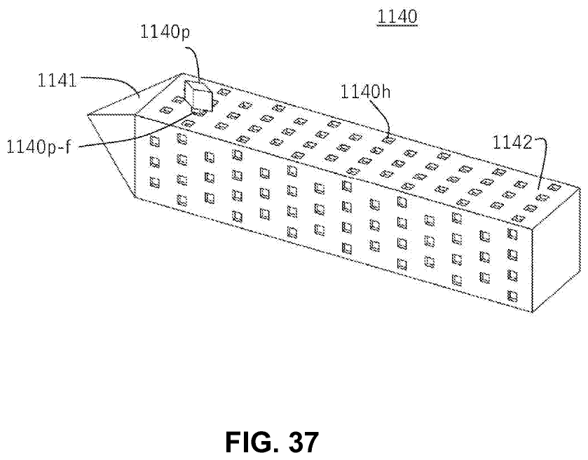

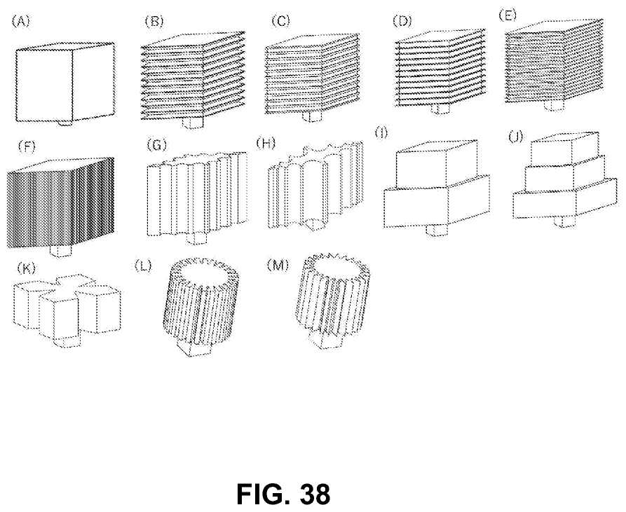

Next, an internal structure 1140 for a fluid supply pipe according to an eleventh embodiment of the present invention, and in particular, the assembly thereof will be described with reference to FIGS. 37 and 38. Although not shown, the shape of the fluid supply pipe in which the internal structure 1140 is housed and fixed is the same as in the embodiments described above.

In the internal structure 1140, or a shaft, a quadrangular pyramid 1141 is provided at a leading end, and a plurality of holes 1140h are formed on each lateral face of a quadrangular prism 1142 connected to and formed integrally with the quadrangular pyramid 1141. The arrangement of these holes 1140h is such that on the four lateral faces, the holes 1140h are arranged in 14 rows of a sequence of three holes, four holes, three holes, . . . , four holes from upstream to downstream, and thus 49 holes 1140h are punched on each lateral face. Therefore, a total of 196 holes are provided on the four lateral faces. Of course, the number and shape of the holes 1140h (square holes with a certain depth in FIG. 37), and the arrangement method thereof may be changed as appropriate. A pillar 1140p having a mounting foot (or a mounting pin) 1140p-f is inserted into and attached to each of the holes 1140h. Accordingly, the shape and depth of each hole 1140h correspond to the shape of the mounting foot 1140pf of the pillar 1140p. Insertion and fixation of the mounting feet 1140p-f into the holes 1140h may be performed manually or by an automatic machine. Although the mounting feet 1140p-f are in the shape of a prism in FIG. 37, they may be in the form of a cylinder or other shapes. When inserting and fixing, the pillars may be press-fitted, impacted, or engaged.

As in other embodiments, the plurality of pillars 1140p have a bottom surface of, for example, a rhombic shape and a top surface that is part of the surface of a cylinder or that is simply a rhombic plane, so that the pillars may be of a quadrangular prism (rhombic prism) as a whole. By adjusting the height of the pillars 1140p stepwise, the height may form part of an arc as a whole, as shown in FIG. 4 of the first embodiment. Furthermore, the seventh embodiment shown in FIG. 28 may be achieved by fixing the height of some of the pillars, for example.

Moreover, by arranging the plurality of pillars 1140p in such a way that at least one of the holes 1140h and the mounting feet 1140p-f has directionality, the direction of the pillars 1140p may be shifted out of being parallel to the longitudinal direction of the shaft, so as to be slightly tilted alternately as shown in, for example, FIG. 31 of the ninth embodiment.

FIG. 38 shows a variety of forms of a pillar having a mounting foot. FIG. 38 (A) is the pillar 1140p described already in FIG. 37, whose lateral faces are flat. In contrast, uneven features or steps are provided on the lateral faces of a pillar to vary the flow of a fluid in the modifications of FIG. 38 (B) to (M). That is, they are for inducing a more complicated flow. A turbulent flow including a small vortex may be easily generated by providing a fine flow path, or a cavitation phenomenon may be more easily induced by forming a narrower flow path. Specifically, parallel uneven features are provided in the horizontal direction as shown in FIGS. 38 (B) to 38 (E). Alternatively, parallel uneven features are provided in the vertical direction as shown in FIG. 38 (F). As shown in FIGS. 38 (G) and (H), uneven features having a plurality of curved surfaces (the cross section of which is of a geometric pattern) are vertically formed. Furthermore, one or more steps are provided as in FIGS. 38 (I) and (J). A shape similar to four petals departing from a rhombic shape may be provided as shown in FIG. 38 (K), or uneven features of grooves may be provided in the vertical direction on the lateral face of a basic cylinder as shown in FIGS. 38 (L) and (M). Further, the lateral faces of a pillar may be provided with a matte pattern or the like, or a texture processing may be performed thereon, though not shown. Since the pillars are individually configured, machining is simpler to produce pillars than in other embodiments in which the pillars are formed integrally, and machining such as cutting, turning, and grinding, or an etching treatment, or a sandblasting process may be easily performed.

In the above, it is described that a quadrangular pyramid 1141 is provided, a quadrangular prism 1142 connected to and formed integrally with the quadrangular pyramid 1141 is prepared along with a plurality of pillars 1140p, and insertion of the mounting foot 1140p-f of a pillar 1140 into each hole 1140h with respect to the quadrangular prism 1142 arranges the plurality of pillars 1140p on the surface in a mesh pattern to manufacture the internal structure 1140. In this case, the internal shaft does not have to be the quadrangular pyramid 1141 and the quadrangular prism connected to the quadrangular pyramid, for example, a triangular pyramid and a triangular prism connected to the triangular pyramid described in the second embodiment (FIG. 7) or the eighth embodiment (FIG. 29) may be used, or may be applied to an internal shaft according to other embodiments. Furthermore, the shape of the pyramid and the shape of the polygonal prism may be appropriately changed (e.g., a combination of a pentagonal pyramid and a pentagonal prism, a combination of a hexagonal pyramid and a hexagonal prism, etc.). Furthermore, it is also readily possible to make the material of the shaft of the internal structure different from that of the pillars. For example, a shaft made of a resin may be prepared, pillars for the shaft may be made of a metallic material, and the pillars may be inserted into and fixed to the holes in the shaft.

### Twelfth Embodiment

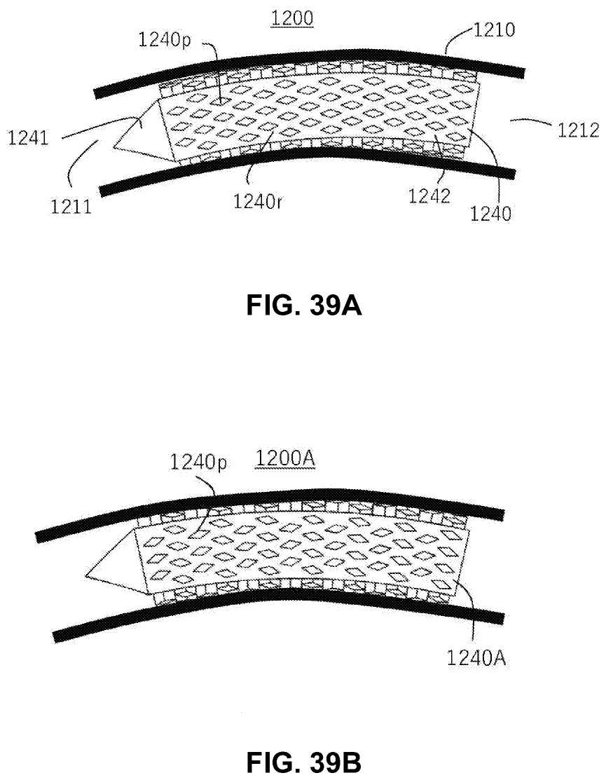

Next, a fluid supply device comprising an internal structure and a tubular body made of an elastic material according to a twelfth embodiment of the present invention will be described with reference to FIGS. 39A and 39B. In the embodiments described above, the description has been given under the assumption that the internal structure and the tubular body are not elastically deformed even if they are made of metal or resin. In this embodiment, a fluid supply pipe 1200 in which the internal structure 1240 and the tubular body 1210 are formed using an elastic material will be described.

An elastomer material, for example, but not limited to, polyvinyl chloride, polyvinylidene chloride, a fluororesin, a silicone resin, and furthermore, a ceramic or the like may be used for the elastic material of the internal structure or the tubular body of the present embodiment. In order to manufacture the internal structure using these elastic materials, a method by injection molding and a method by a 3D printer, which will be described later in a fourteenth embodiment, may be employed. Since the internal structure 1240 made of these techniques has an elastic force, the fluid supply pipe 1200 may be connected to a flexible article such as a hose (in this case, the tubular body is also made of an elastic material), or the fluid supply pipe 1200 may be integrally installed within such an article. As shown in FIG. 39A, the fluid supply pipe 1200 has an inlet 1211 through which a fluid flows in and an outlet 1212 through which a fluid flows out as in other embodiments described above, and has a hollow tubular body 1210 having an inner wall surface of a circular cross section, and an internal structure 1240 that is a prismatic shaft (a quadrangular prism 1242 in FIG. 39A) having a plurality of lateral faces (what is shown in FIG. 39A has four faces, but may have three planes or more faces) that is housed in and fixed to the tubular body 1210. The tubular body 1210 and the internal structure 1240 are formed of an elastic material having elasticity, and are elastically deformed as a whole. For example, the tubular body 1210 may be in the shape of a hose. A pyramid (a quadrangular pyramid 1241 in FIG. 39A) is provided on the inlet side of the internal structure 1240. The shape of the pyramid may also be appropriately changed according to the number of lateral faces of the prism included in the shaft. A plurality of pillars 1240p are arranged in a mesh pattern on the lateral faces of the quadrangular prism 1242 the same as in other embodiments described above, and are present between the lateral faces of the quadrangular prism 1242 of the internal structure 1240 and the inner wall surface of the tubular body 1210, and the space formed between the plurality of pillars 1240p serves as a fluid flow path. A fluid is supplied from the inlet 1211 of the tubular body 1210 and is dispersed by the quadrangular pyramid 1241 toward each lateral face of the quadrangular prism 1242. Then, flow characteristics are given by passing through the flow paths 1240r between the plurality of pillars 1240p. Thereafter, the fluid flows out of the outlet 1212.

As described above, both the tubular body 1210 and the internal structure 1240 have elasticity, and the fluid supply pipe 1200 can be used for applications (e.g., mounted to a flexible hose, for example, a cleaning hose) that need to be bent as a whole in the present embodiment. In addition, only the internal structure 1240 may have elasticity to be received in a tubular body 1210 of a bent shape that does not have elasticity. For example, the internal structure 1240 may be used in a bent shape for a shower head having no space, a faucet, and other fluid discharge devices.

FIG. 39B is a modification of the twelfth embodiment (FIG. 39A), in which a plurality of pillars 1240p provided on the internal structure 1240A of the fluid supply pipe 1200A are formed in a plurality of rows, and for each row, the direction of the pillars 1240p is slightly tilted alternately indifferent direction to the left and right from the longitudinal direction of the shaft of the internal structure 1240A as in the ninth embodiment (e.g., see FIG. 32A and FIG. 32B). In this modification, since the pillars 1240p are slightly tilted in different directions to the left and right for each row and accordingly part of the pillars 1240p protrudes to the flow paths, the frequency of collision of the fluid with the pillars 1240p increases over the collision frequency of FIG. 39A and turbulent flows are generated including a number of small vortices, thereby increasing the effect of shearing, stirring, diffusing, and mixing the fluid. Further, such a feature is also effective in generating fine bubbles.

### Thirteenth Embodiment

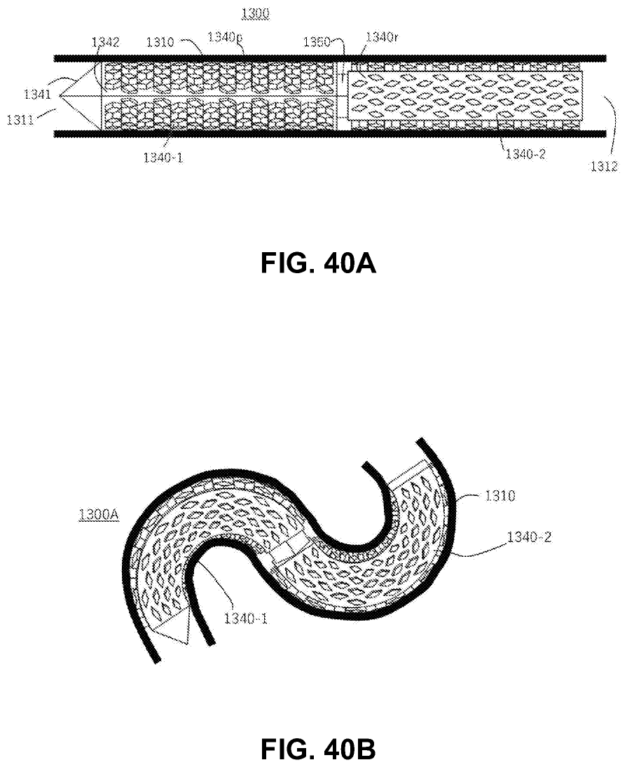

Next, a thirteenth embodiment of the present invention will be described with reference to FIGS. 40A and 40B. In the present embodiment, a fluid supply pipe 1300 is configured by connecting a plurality of component internal structures. A plurality of internal structures (component internal structures) 1340-1 and 1340-2 are arranged in a tubular body 1310. Though FIG. 40A and FIG. 40B show just two internal structures, the number is not limited thereto and three or more component internal structures may also be connected.

A pyramid (a quadrangular pyramid 1341 in FIG. 40A) is provided at the leading end of the internal structure 1340-1 installed upstream of the tubular body 1310. The shape of the pyramid may also be appropriately changed according to the number of lateral faces of the prism included in the shaft. A plurality of pillars 1340p are arranged in a mesh pattern on the lateral faces of the quadrangular prism 1342 as in other embodiments described above, and are present between the lateral faces of the quadrangular prism 1342 of the internal structure 1340-1 and the inner wall surface of the tubular body 1310, and a space formed between the plurality of pillars 1340p servers as a fluid flow path 1340r. In FIG. 40A, since the pillars 1340p are slightly tilted in different directions to the left and right for each row, part of the pillars 1340p protrudes to the flow paths, but the pillars 1340p may all be parallel to the longitudinal direction of the shaft. Then, this internal structure 1340-1 and an internal structure 1340-2 on the downstream side are connected to each other via a connecting portion 1350 of a prismatic shape (a quadrangular prism in FIG. 40A). Further, the shape of the connecting portion 1350 may also be a cylindrical shape. The downstream internal structure 1340-2 has the same configuration and the same functionality as that of the quadrangular prism 1342 of the upstream internal structure 1340-1, the quadrangular prism 1342 of the internal structure 1340-1 and the internal structure 1340-2 are relatively rotated and connected to each other. That is, for example, they are connected to each other by being rotated by 90 degrees as shown in FIG. 40A. By such connection with certain rotation, the fluid given individual flow characteristics in the four lateral faces 1342 of the upstream internal structure 1340-1 is mixedly supplied to another plurality of lateral faces of the downstream internal structure 1340-2, and is turned into a more complicated fluid flow, thereby having a greater influence on imparting flow characteristics.

FIG. 40B shows a modification in which the tubular body 1310 and the plurality of internal structures (component internal structures) 1340-1 and 1340-2 shown in FIG. 40A both have elastic characteristics. Thus, the fluid supply pipe 1300A in which both the tubular body 1310 and the plurality of internal structures 1340-1 and 1340-2 are made of an elastic material is capable of elastic deformation or bending deformation as a whole, and may be connected to a flexible hose or may be installed inside the hose. In addition, a pyramid (a quadrangular pyramid in the case of FIG. 40A or 40B) may be provided integrally on the downstream side of the most downstream internal structure (the internal structure 1340-2 in FIG. 40A or FIG. 40B) to guide the fluid to the center thereof.

### Fourteenth Embodiment

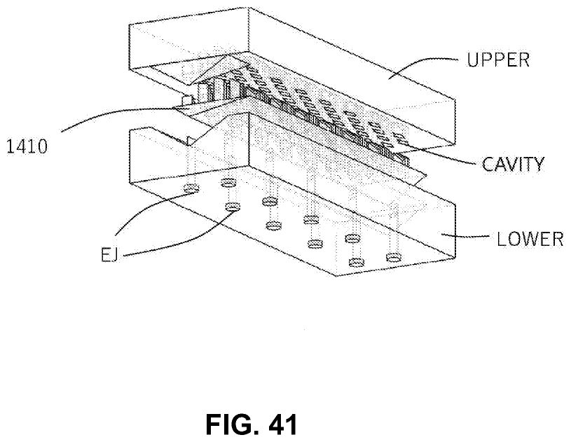

Next, a method of manufacturing an internal structure by injection molding according to a fourteenth embodiment of the present invention will be described with reference to FIGS. 41 to 43B. FIG. 41 shows a process of manufacturing partial internal structures by injection molding. In particular, a component internal structure 1410 is injection molded with a material such as plastic. In the present embodiment, a ⅓ component internal structure 1410 of the internal structure having a triangular prism shaft in the embodiments described above is formed.

In FIG. 41, a resin is injected into a cavity CAVITY from an upper injection port (not shown) and is solidified between an upper mold UPPER and a lower mold LOWER, and then is extruded and ejected by a plurality of ejector pins EJ. In this case, the upper mold UPPER comprises a convex portion configured to form the shape of a ⅓ portion of the triangular pyramid of the component internal structure 1410, a concave portion CAVITY and a flat surface as a convex portion in the shape in which the convexity and concavity of the pillars (convex portion) and flow paths (concave portion) to be formed on the lateral faces of the triangular prism are reversed. Further, a V-shaped concave portion configured to form a ⅓ triangular prism is formed in the lower mold LOWER.

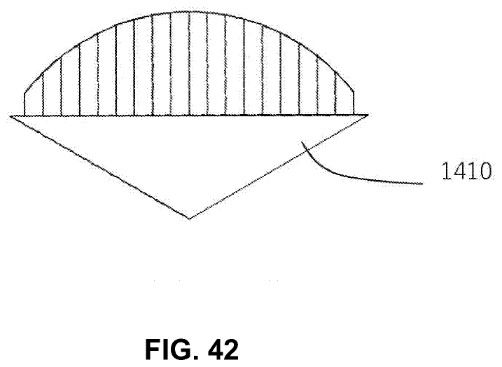

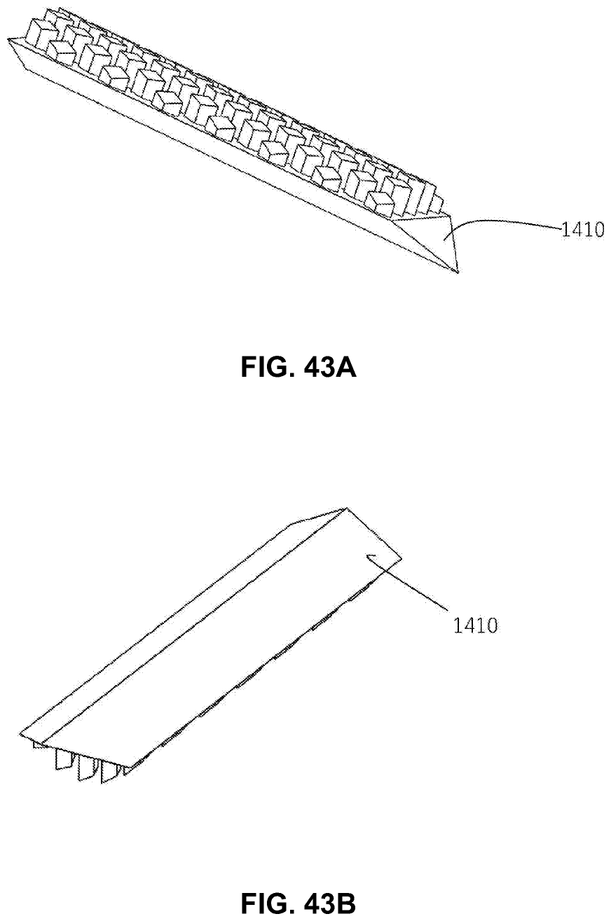

FIG. 42 shows a side view of the ⅓ partial internal structure 1410 formed by such injection molding, and FIGS. 43A and 43B are three-dimensional perspective views of the ⅓ partial internal structure 1410 viewed from different angles. As such, since a ⅓ component internal structure 1410 of the internal structure of the triangular prism shaft can be obtained by injection molding in the present embodiment, three partial internal structures 1410 may be combined (specifically, bonding, welding, compacting, etc.) to form one internal structure. As a result, an internal structure formed by combining a plurality of partial internal structures 1410 into a single unit has a prismatic shape having a plurality of lateral faces, and a plurality of pillars are arranged in a mesh pattern on respective lateral faces. In this case, an internal structure formed by combining a plurality of partial internal structures may have elasticity depending on the materials used in injection molding.

Though a ⅓ partial internal structure was injection molded in the example described above, there are many ways of dividing an internal structure, for example, in the case of an internal structure of a quadrangular prism shaft, a ½ partial internal structure is injection molded, and then the two partial internal structures may be combined into one internal structure. Moreover, a ¼ partial internal structure may be injection molded first, and then the four partial internal structures may be combined to form one internal structure of a quadrangular prism shaft. In the case of other internal structures having a polygonal prism shaft, an appropriate number of partial internal structures may be combined into one internal structure.

In the above, though the present invention has been described using a plurality of embodiments, the present invention is not limited to such embodiments. For example, though the internal structure (outer internal structure) has been configured as a triangular prism or a quadrangular prism, the internal structure is not limited thereto, and even for a prism with five or more lateral faces (pentagonal prism or more), a plurality of pillars may be formed in a mesh pattern on each lateral face, and intersecting flow paths may be provided therebetween, as in the embodiments described above. Also, the inner internal structure may take the form of a pentagonal prism or more. According to the shape of a hollow cavity formed in an outer internal structure, a prism or a cylinder having a different number of lateral faces from the prism of the outer internal structure may also be employed. That is, for example, even if the prism of an outer internal structure is a quadrangular prism, it may be possible to use a triangular prism as the prism of an inner internal structure. Further, an outer internal structure may be a hexagonal prism and an inner internal structure may be a cylinder. Furthermore, the size of the pillars formed on the lateral faces of a prism is all the same from upstream to downstream, but is not limited thereto. Specifically, pillars on the upstream side may be made larger and pillars on the downstream side may be made smaller. For example, the first seven rows of pillars may be provided with pillars of a smaller size (each side of the rhombic bottom is made shorter) out of the 14 rows of pillars (see FIGS. 5A, 5B, 8B, 13A, 13B, 18A, 18B, 32A, 32B, 35A, 35B, 37, 39A, 39B, 40A and 40B), and the latter half may remain unchanged as illustrated. Further, though two members (two layers) of the inner internal structure and the outer internal structure are housed in the tubular body in the third to sixth embodiments, the internal structure may comprise three or more members (three layers) to be housed and used in combination. Specifically, for example, three (three layers of) internal structure shafts of large, medium, and small are used so that a plurality of intersecting flow paths are formed to provide a plurality of pillars in a mesh pattern on each lateral face, the small internal structure is housed in and fixed to the medium internal structure having a hollow cavity formed therein, and then a unified internal structure having the small internal structure and the medium internal structure assembled together is housed in and fixed to the large internal structure having a hollow cavity formed therein. A person skilled in the art to which the present invention pertains can derive many variations and other embodiments of the present invention from the above description and the related drawings. Although a plurality of specific terms are used herein, they are used in a generic sense only for illustrative purposes and are not intended to limit the invention. Various modifications may be made without departing from the general concept and spirit of the invention as defined by the appended claims and their equivalents.

What is claimed is:

1. A fluid supply device comprising:
a hollow tubular body having an inlet through which a fluid flows in and an outlet through which the fluid flows out, the tubular body having an inner wall surface of a circular cross section; and
an internal structure configured to be housed in and fixed to the tubular body, the internal structure being a prismatic shaft having a plurality of lateral faces,
wherein a plurality of pillars are arranged in a mesh pattern on the lateral faces of the internal structure, and
a space formed between the plurality of pillars and also between the lateral faces of the internal structure and the inner wall surface of the tubular body serves as fluid flow paths, and the fluid is given a flow characteristic by passing through the flow paths between the plurality of pillars while the fluid is supplied from the inlet of the tubular body and flows out of the outlet.

2. The fluid supply device according to claim 1, wherein a pyramid is provided on an inlet side of the prismatic internal structure to disperse and supply an inflowing fluid to the plurality of lateral faces.

3. The fluid supply device according to claim 2, wherein the internal structure is a shaft of a shape of a triangular prism or a quadrangular prism, and the pyramid provided in the internal structure is a triangular pyramid or a quadrangular pyramid.

4. The fluid supply device according to claim 1, wherein the flow paths formed between the plurality of pillars are intersecting flow paths in which two flow paths of a flow path in a direction from a left diagonal upstream side to a right diagonal downstream side and a flow path in a direction from a right diagonal upstream side to a left diagonal downstream side intersect each other from upstream to downstream, and the fluid flows at the same intensity in the two flow paths.

5. The fluid supply device according to claim 1, wherein a shape of a bottom surface of the pillars is a rhombus, and two vertices of an acute angle of the rhombus are positioned parallel to a longitudinal direction of the shaft of the internal structure.

6. The fluid supply device according to claim 1, wherein the pillars are formed in a plurality of rows, and for each row, a direction of the pillars is slightly tilted alternately to left and right direction from a longitudinal direction of the shaft of the internal structure.

7. The fluid supply device according to claim 6, wherein a shape of a bottom surface of the pillars is a rhombus, and is slightly tilted from the longitudinal direction of the shaft of the internal structure around a center the rhombus.

8. The fluid supply device according to claim 5, wherein a shape of a top surface of the pillars is a curved surface of a part of a lateral face of a cylinder, and a radius of the cylinder is equal to or slightly smaller than a radius of the circular cross section of the tubular body.

9. The fluid supply device according to claim 1, wherein uneven features are formed on lateral faces of the plurality of pillars.

10. The fluid supply device according to claim 1, wherein one or more steps are provided on lateral faces of the plurality of pillars.

11. The fluid supply device according to claim 1, wherein the internal structure is made of an elastic material having elasticity, to be elastically deformable as a whole.

12. The fluid supply device according to claim 11, wherein the tubular body and the internal structure are both made of an elastic material having elasticity, to enable the internal structure together with the tubular body to be elastically deformed.

13. The fluid supply device according to claim 1, wherein a cross-sectional area of the flow paths between the plurality of pillars is smaller than a cross-sectional area of an upstream flow path, and a cavitation phenomenon is induced by reducing a static pressure of the fluid flowing through the flow paths between the plurality of pillars, thereby generating fine bubbles.

14. The fluid supply device according to claim 1, wherein the fluid is given at least one flow characteristic out of (i) whether to generate a large number of fine bubbles, (ii) whether to mix a plurality of fluids, or (iii) whether to stir and diffuse the fluid, while the fluid flows through the flow paths between the pillars.

15. The fluid supply device according to claim 1, wherein
the internal structure that is a prismatic shaft comprises a hollow,
a second internal structure is housed in and fixed to the hollow of the internal structure,
a plurality of pillars are arranged in a mesh pattern on an outer surface of the second internal structure,
a space formed between the plurality of pillars and also between the outer surface of the second internal structure and an inner wall surface of the hollow internal structure serves as fluid flow paths, and
the fluid is given a flow characteristic by passing through the flow paths between the plurality of pillars of the second internal structure while the fluid is supplied from the inlet of the tubular body and flows out of the outlet.

16. The fluid supply device according to claim 15, wherein the hollow provided in the prismatic internal structure is of a prismatic shape, the second internal structure is a prismatic shaft having a plurality of lateral faces, and the plurality of pillars are provided on the lateral faces of the prismatic shaft.

17. The fluid supply device according to claim 15, wherein the hollow provided in the prismatic internal structure is of a cylindrical shape, the second internal structure is a cylindrical shaft, and the plurality of pillars are provided on a lateral face of the cylindrical shaft.

18. The fluid supply device according to claim 1, wherein a height of a top surface of the plurality of pillars provided on an outer surface of the internal structure is higher at a center thereof and gets lower toward outside as a whole, in accordance with an arc of the inner wall surface of the tubular body.

19. The fluid supply device according to claim 1, wherein a height of some of the plurality of pillars is reduced to prevent pressure loss of the fluid.

20. A machine tool, configured to inject cooling water into the fluid supply device according to claim 1, to impart a predetermined flow characteristic to the fluid, and then to discharge the fluid to a tool or workpiece to cool the tool or workpiece.

21. A shower nozzle, configured to inject cold water and hot water into the fluid supply device according to claim 1, to impart a predetermined flow characteristic to the fluid, and then to discharge the fluid to enhance an effect of cleaning.

22. A fluid mixing device, configured to inject a plurality of fluids having different properties into the fluid supply device according to claim 1, to impart a predetermined flow characteristic to the fluids, and to mix and then to discharge the plurality of fluids.

23. A hydroponic device, configured to inject water into the fluid supply device according to claim 1, to increase an amount of dissolved oxygen, and then to discharge the water.

24. An internal structure, configured to be housed in a housing and to impart a flow characteristic to a fluid, wherein
the internal structure has a prismatic internal shaft having a plurality of lateral faces,
a plurality of pillars are arranged in a mesh pattern on the lateral faces of the internal shaft,
a space formed between the plurality of pillars serves as fluid flow paths, and
the fluid is given a flow characteristic by passing through the flow paths between the plurality of pillars.

25. The internal structure according to claim 24, wherein
the prismatic internal shaft comprises a hollow,
a second internal shaft is housed in and fixed to the hollow of the internal shaft,
a plurality of pillars are arranged in a mesh pattern on an outer surface of the second internal shaft,
a space formed between the plurality of pillars and also between the outer surface of the second internal shaft and an inner wall surface of the hollow internal shaft serves as fluid flow paths, and
the fluid is given a flow characteristic by passing through the flow paths between the plurality of pillars of the second internal shaft.

26. The internal structure according to claim 25, wherein the hollow provided in the prismatic internal shaft is of a prismatic shape, the second internal shaft is a prismatic shaft having a plurality of lateral faces, and the plurality of pillars are provided on the lateral faces of the prismatic shaft.

27. The internal structure according to claim 25, wherein the hollow provided in the prismatic internal shaft is of a cylindrical shape, the second internal shaft is a cylindrical shaft, and the plurality of pillars are provided on a lateral face of the cylindrical shaft.

28. A method for manufacturing an internal structure configured to be housed in a housing and to impart a flow characteristic to a fluid, comprising:
a step of preparing a cylindrical internal shaft; and
a step of forming a plurality of pillars arranged in a mesh pattern with a bottom surface thereof as a lateral face of a prismatic shaft and a top surface thereof as a lateral face of a cylindrical shaft by forming intersecting flow paths with the bottom surface as the lateral face of the prismatic shaft and the top surface as an outer diameter of the cylindrical shaft, for the cylindrical internal shaft.

29. The method for manufacturing an internal structure according to claim 28, wherein the forming intersecting flow paths is performed by cutting.

30. The method for manufacturing an internal structure according to claim 28, further comprising a step of forming one end of the internal shaft on an inlet-side of a fluid into a pyramid.

31. A method for manufacturing an internal structure configured to be housed in a housing and to impart a flow characteristic to a fluid, comprising:
a step of preparing an inner internal shaft;
a step of forming a plurality of pillars arranged in a mesh pattern by making intersecting flow paths on an outer surface, for the inner internal shaft;
a step of preparing a cylindrical outer internal shaft;
a step of forming a hollow cavity in which the inner internal shaft is disposed, for the outer internal shaft;
a step of forming a plurality of pillars arranged in a mesh pattern with a bottom surface thereof as a lateral face of a prismatic shaft and a top surface thereof as a lateral face of a cylindrical shaft by forming intersecting flow paths with the bottom surface as the lateral face of the prismatic shaft and the top surface as an outer diameter of the cylindrical shaft, for the cylindrical outer internal shaft; and
a step of disposing the inner internal shaft having the plurality of pillars formed thereon in the hollow cavity of the outer internal shaft having the plurality of pillars formed thereon.

32. The method for manufacturing an internal structure according to claim 31, wherein
in the step of preparing an inner internal shaft, a prismatic shaft is prepared,
in the step of forming a hollow cavity, for the outer internal shaft, a prismatic hollow cavity is formed therethrough, and
in the step of forming a plurality of pillars, for the inner internal shaft, a plurality of pillars are formed with the bottom surface being the same height as a bottom surface of the intersecting flow paths and the top surface being a height of the lateral face of the prismatic shaft by forming intersecting flow paths of a predetermined depth from the lateral face of the prismatic shaft.

33. The method for manufacturing an internal structure according to claim 31, wherein
in the step of preparing an inner internal shaft, a cylindrical shaft is prepared,
in the step of forming a hollow cavity, for the outer internal shaft, a cylindrical hollow cavity is formed therethrough, and
in the step of forming a plurality of pillars, for the inner internal shaft, a plurality of pillars are formed with the bottom surface being the same height as a bottom surface of the intersecting flow paths and the top surface being a height of the lateral face of the cylindrical shaft by forming intersecting flow paths of a predetermined depth from the lateral face of the cylindrical shaft.

34. An internal structure, configured to be housed in a housing and to impart a flow characteristic to a fluid, wherein
the internal structure is formed by connecting a plurality of component internal structures,
each component internal structure is configured such that:
the component internal structure has a prismatic internal shaft having a plurality of lateral faces, a plurality of pillars are arranged in a mesh pattern on the lateral faces of the internal shaft, a space formed between the plurality of pillars serves as fluid flow paths, and the fluid is given a flow characteristic by passing through the flow paths between the plurality of pillars, and
the plurality of component internal structures are connected to one another with an angle relatively rotated therebetween.

35. The internal structure according to claim 34, wherein the component internal structure is made of an elastic material having elasticity, to be deformable as a whole.

36. A method for manufacturing an internal structure configured to be housed in a housing and to impart a flow characteristic to a fluid, comprising:
a step of preparing a plurality of pillars each having a mounting foot;
a step of preparing a prismatic internal shaft having a plurality of holes formed thereon arranged in a mesh pattern, into which the plurality of pillars are disposed; and
a step of arranging and forming the plurality of pillars in a mesh pattern on a surface of the internal shaft by inserting the mounting foot of each pillar into each hole, for the internal shaft.

37. A method for manufacturing an internal structure configured to be housed in a housing and to impart a flow characteristic to a fluid, comprising:
a first step of manufacturing partial internal structures by injection molding; and
a second step of combining a plurality of the partial internal structures into one internal structure,
wherein the internal structure formed by combining the plurality of partial internal structures into one is of a prismatic shape having a plurality of lateral faces, and a plurality of pillars are arranged in a mesh pattern on each of the lateral faces.

38. The method for manufacturing an internal structure according to claim 37, wherein the partial internal structures are manufactured by injection molding for each of the plurality of lateral faces of the internal structure.
